(19) United States
(12) Patent Application Publication
(10) Pub. No.: US 2014/0228218 A1
(43) Pub. Date: Aug. 14, 2014

(54) PARAFFINIC OIL AND CLASS B GIBBERELLIN BIOSYNTHESIS INHIBITOR COMPOSITIONS

(71) Applicants: Michael Fefer, Whitby (CA); Jun Liu, Oakville (CA)

(72) Inventors: Michael Fefer, Whitby (CA); Jun Liu, Oakville (CA)

(73) Assignee: SUNCOR ENERGY INC., Calgary, AB (CA)

(21) Appl. No.: 14/123,681

(22) PCT Filed: Jun. 4, 2012
(86) PCT No.: PCT/CA2012/050374

§ 371 Date: Feb. 26, 2014

Related U.S. Application Data
(60) Provisional application No. 61/493,291, filed on Jun. 3, 2011.

(51) Int. Cl. A01N 43/653

(52) U.S. Cl. CPC A01N 43/653
USPC 504/181

(57) ABSTRACT

This disclosure features combinations that include a paraffinic oil and a Class B gibberellin biosynthesis inhibitor. The combinations can further include (but are not limited to) one or more of the following: one or more emulsifiers, one or more pigments, one or more silicone surfactants, one or more anti-settling agents, and water. This disclosure also features methods of using the combinations for promoting health of a plant (e.g., turf grass) as well as methods of formulating combinations that include both oil and water as oil-in-water (O/W) emulsions.

### CROSS REFERENCE TO RELATED APPLICATIONS

This application claims the benefit of U.S. Provisional Application No. 61/493,291, filed on Jun. 3, 2011, which is incorporated by reference in its entirety.

### TECHNICAL FIELD

This disclosure features combinations that include one or more paraffinic oils and one or more Class B gibberellin biosynthesis inhibitors. The combinations can further include (but are not limited to) one or more of the following: one or more emulsifiers, one or more pigments, one or more silicone surfactants, one or more anti-settling agents, and water. In some implementations, the combinations can be in the form of a single composition (e.g., which is contained within a storage pack or a vessel (e.g., a tank) suitable for applying the composition to a plant, e.g., turf grass). Typically, the composition is applied to a plant (e.g., turf grass) after dilution with water. In other implementations, the combinations can include two or more separately contained (e.g., packaged) compositions, each containing one or more of the above-mentioned components. Said compositions can be combined and applied to a plant (e.g., turf grass) with or without prior dilution with water; or each composition can be applied separately to the same plant (e.g., turf grass) either simultaneously or sequentially, and typically after dilution with water. This disclosure also features methods of using the combinations for promoting health of a plant (e.g., turf grass) as well as methods of formulating combinations that include both oil and water as oil-in-water (O/W) emulsions.

### BACKGROUND

Grasses are often planted and maintained to provide aesthetically pleasing or recreationally useful groundcover for an area of land, which may be called a lawn, turf, pitch, field or green depending on the context. Species of grasses that are maintained in this way are sometimes referred to as turf grasses. Turf grass care and maintenance has a rich horticultural tradition, reflecting in part the numerous economic and environmental benefits provided by turf grasses (see, for example, Walsh, B. et al., HortScience, 34, 1999, 13-21).

Plant growth regulators have been employed in turf grass management strategies for a number of different purposes, for example, for slowing grass growth to reduce clipping production or mowing frequency, improving grass health and stress relief associate with frequent and/or short mowings, reducing trimming and edging, for managing annual bluegrass (Poa annua), and promoting the growth of one grass species or cultivar over another. A number of classification systems for plant growth regulators have been developed, including a system based on mode of action into Classes A, B, C, D, and E. Class B plant growth regulators are gibberellic acid inhibitors which interfere with GA production early in the biosynthetic pathway.

Class B gibberellin biosynthesis inhibitors have sometimes been described as interfering with the biosynthesis of gibberellic acid before the production of the first gibberellic acid compound, GA₁₂. GA₁₂ is thought to be a precursor for many other gibberellic acids, and it is believed that gibberellic acid production may be substantially slowed by the use of Class B gibberellin biosynthesis inhibitors. Plant growth regulation compositions comprising combinations of Class A gibberellin biosynthesis inhibitors with Class B gibberellin biosynthesis inhibitors, including flurprimidol and paclobutrazol, for regulating growth of turf grasses have been reported (see, for example, U.S. Pat. No. 7,135,435). It has been reported that inhibitors such as flurprimidol and paclobutrazol (sold under the names Cutless™ and TRIMMIT™, respectively) can cause phytoxicity to the plant being treated (see, for example, B. Huang “Plant growth regulators: What and why” GCM, January (2007) pages 157-160).

Dollar spot, thought to be caused by the fungal pathogen Sclerotinia homoeocarpa, is a common disease affecting turf grass species, with symptoms that vary according to species and management practices. Characteristic symptoms of dollar spot infection include bleached, circular patches, with patches sometimes occurring in clusters, particularly on grasses cut short, such as golf course fairways, tees, and greens. A number of management practices are known for controlling dollar spot disease in turf grasses, including managing leaf wetness, or preventing moisture or nitrogen stress.

Oil-in-water emulsions comprising paraffinic oils and paraffinic spray oils have been used in turf grass management practices for controlling turf grass pests (see, for example, Canadian Patent Application 2,472,806 and Canadian Patent Application 2,507,482). In addition, oil-in-water formulations comprising paraffinic oils and a pigment for controlling turf grass pests have been reported (see, for example, WO 2009/155693). For example, Petro-Canada produces CIVITAST™, a broad spectrum fungicide and insecticide for use on golf course turf and landscape ornamentals, used for example to control powdery mildew, adelgids and webworms on landscape ornamentals (US EPA REG. NO. 69526-13). Product labeling indicates that CIVITAST™ may be applied as part of an alternating spray program or in tank mixes with other turf and ornamental protection products; and that CIVITAST™ may be used as a preventative treatment with curative properties for the control of many important diseases on turf, including fairways and roughs.

### SUMMARY

This disclosure features combinations that include one or more paraffinic oils and one or more Class B gibberellin biosynthesis inhibitors. The combinations can further include (but are not limited to) one or more of the following: one or more emulsifiers, one or more pigments, one or more silicone surfactants, one or more anti-settling agents, and water. In some implementations, the combinations can be in the form of a single composition (e.g., which is contained within a storage pack or a vessel (e.g., a tank) suitable for applying the composition to a plant, e.g., turf grass). Typically, the composition is applied to a plant (e.g., turf grass) after dilution with water. In other implementations, the combinations can include two or more separately contained (e.g., packaged) compositions, each containing one or more of the above-mentioned components. Said compositions can be combined and applied to a plant (e.g., turf grass) with or without prior dilution with water; or each composition can be applied separately to the same plant (e.g., turf grass) either simultaneously or sequentially, and each typically after dilution with water. This disclosure also features methods of using the combinations for promoting health of a plant (e.g., turf grass) as well as methods of formulating combinations that include both oil and water as oil-in-water (O/W) emulsions.

Plant growth regulators, such as Class B gibberellin biosynthesis inhibitors flurprimidol (Cutless™) and Paclobutrazol (TRIMMIT™), are often used to limit turf growth, e.g., to reduce the need for mowing. However, it has been reported that the phytoxicity associated with these products can cause plant quality to decline (see, for example, B. Huang “Plant growth regulators: What and why” GCM, January (2007) pages 157-160). It has been surprisingly found that the combinations described herein (e.g., combinations that include paclobutrazol or flurprimidol and the components present in CIVITAS™/CIVITAS HARMONIZER™) regulate growth of a plant (e.g., turf grass) and reduce the phytotoxic effect of the applied Class B gibberellin biosynthesis inhibitor. In some implementations, a turf grass treated with the combinations described herein exhibits a turf quality of greater than or equal to 6 after application of the combinations described herein (or after each application when the combinations described herein are applied more than once to the same area of turf grass).

It has also been surprisingly found that the combinations described herein (e.g., combinations that include paclobutrazol or flurprimidol and the components present in CIVITAS™/CIVITAS HARMONIZER™) have a significant positive impact on controlling fungal disease caused by a fungal pathogen of a plant (e.g., in which the fungal pathogen is a fungus that causes dollar spot disease). In some implementations, the combined effect of two (or more) components of the combination (e.g., the paraffinic oil and Class B gibberellin biosynthesis inhibitor) on controlling fungal disease can be greater than the expected sum of each component's individual effect on controlling a fungal disease (e.g., controlling dollar spot disease). In certain implementations, the combined effect of the two (or more) components present in the combinations described herein can be a synergistic effect. In certain implementations, the paraffinic oil and Class B gibberellin biosynthesis inhibitor exhibit a synergistic effect in controlling fungal disease (e.g., controlling dollar spot disease).

In one aspect, a composition that includes a paraffinic oil, a Class B gibberellin biosynthesis inhibitor, and an emulsifier is featured.

In another aspect a combination is featured that includes a first and separately contained composition and a second and separately contained composition, in which:

the first and separately contained composition includes a paraffinic oil, a Class B gibberellin biosynthesis inhibitor, and an emulsifier; and

the second and separately contained composition includes a pigment and a silicone surfactant.

In a further aspect, a combination is featured that includes a first and separately contained composition, a second and separately contained composition, and a third and separately contained composition, in which:

the first and separately contained composition includes a paraffinic oil and an emulsifier;

the second and separately contained composition includes a pigment and a silicone surfactant; and

the third and separately contained composition includes a Class B gibberellin biosynthesis inhibitor.

In one aspect, methods of regulating growth of a turf grass are featured that include applying a combination (e.g., a composition, e.g., a concentrate) as described anywhere herein to a plant (e.g., turf grass).

In another aspect, uses of a combination (e.g., composition, e.g., a concentrate) as described anywhere herein for regulating growth of a turf grass are featured.

In one aspect, methods of controlling a fungal pathogen of a plant (or a disease caused by such a pathogen) are featured, which includes applying a combination (e.g., a composition, e.g., a concentrate) as described anywhere herein to a plant (e.g., turf grass).

In another aspect, uses of a combination (e.g., a composition, e.g., a concentrate) as described anywhere herein for controlling a fungal pathogen of a plant (or a disease caused by such a pathogen) of a plant (e.g., turf grass) are featured.

Implementations can include any one or more of the following features.

The Class B gibberellin biosynthesis inhibitor has formula V as described anywhere herein (e.g., α-(1-methylethyl)-α-[4-(trifluoromethoxy)phenyl]-5-pyrimidinemethanol (flurprimidol).

The Class B gibberellin biosynthesis inhibitor has formula VI as described anywhere herein (e.g., (±)-(R*,R*)-beta-[(4-chlorophenyl)methyl]-alpha-(1,1-dimethylethyl)-1H-1,2,4-triazole-1-ethanol (paclobutrazol)).

The weight ratio of paraffinic oil to the emulsifier can be from 100:1 to 10:1 (e.g., 50:1).

The paraffinic oil includes a paraffin having from 16 carbon atoms to 35 carbon atoms.

The paraffinic oil has a paraffin content of at least 80%.

The paraffinic oil includes synthetic isoparaffins.

The weight percent ratio of the Class B gibberellin biosynthesis inhibitor to the paraffinic oil can be from 1:5 to 1:5000., e.g., from 1:100 to 1:150.

The emulsifier includes a natural or synthetic alcohol ethoxylate, an alcohol alkoxylate, an alkyl polysaccharide, a glycerol oleate, a polyoxyethylene-polyoxypropylene block copolymer, an alkyl phenol ethoxylate, a polymeric surfactant, a polyethylene glycol, a sorbitan fatty acid ester ethoxylate, or a composition thereof; e.g., the emulsifier comprises a natural or synthetic alcohol ethoxylate.

The composition further includes a pigment (e.g., polychlorinated (Cu II) phthalocyanine).

The weight ratio of paraffinic oil to the pigment can be from 5:1 to 100:1; e.g., 30:1.

The composition further includes a silicone surfactant.

The silicone surfactant further includes a polyethylene glycol according to formula IV:

R¹—O—(CH₂CH₂O)_{f}—R²

wherein R¹=H or CH₂═CH—CH₂ or COCH₃; R²=H or CH₂═CH—CH₂ or COCH₃; and f≧1.

The weight ratio of pigment to the silicone surfactant can be from 2:1 to 50:1 (e.g., 3.5:1).

The pigment can be stably dispersed in the composition.

The composition further includes an anti-settling agent (e.g., fumed silica).

The composition includes:

| | | |
|---|---|---|
| paraffinic oil | 50 to 200 | parts per weight |
| Class B gibberellin biosynthesis inhibitor | 0.1 to 10 | parts per weight |
| emulsifier | 1 to 10 | parts per weight |
| pigment | 1 to 10 | parts per weight |
| silicone surfactant and polyethylene glycol | 0.1 to 10 | parts per weight |
| anti-settling agent | 0.5 to 20 | parts per weight |

The composition includes:

| | | |
|---|---|---|
| paraffinic oil | 100 | parts per weight |
| Class B gibberellin biosynthesis inhibitor | 1 | parts per weight |
| emulsifier | 2 | parts per weight |
| pigment | 3.5 | parts per weight |
| silicone surfactant and polyethylene glycol | 1 | parts per weight |
| anti-settling agent | 2 | parts per weight |

The composition further comprises water. In certain implementations, the composition is in the form of an oil in water emulsion.

The turf grass exhibits a turf quality of greater than or equal to 6 after applying the composition.

The application of the composition can be repeated one or more times. The turf grass exhibits a turf quality of greater than or equal to 6 during each time interval between each application of the composition. The time interval between each application of the composition can be from 14 to 28 days.

The turf grass can be one or more of: bentgrass, bluegrass, ryegrass, fescue, bermudagrass, hybrid bermudagrass, St. Augustinegrass, seashore paspalum, or zoysiagrass.

The turf grass can be one or more of: bentgrass, Kentucky bluegrass, annual bluegrass, perennial ryegrass, tall fescue, common bermudagrass, Tifway bermudagrass, Tifsport bermudagrass, Tifgreen bermudagrass, GN-1 bermudagrass, Ormond bermudagrass, seashore paspalum, Bitter Blue St. Augustinegrass, Seville St. Augustinegrass, Floratam St. Augustinegrass, Floralawn St. Augustinegrass, Floratine St. Augustinegrass, Raleigh St. Augustinegrass, Texas Common St. Augustinegrass, or zoysiagrass.

The Class B gibberellin biosynthesis inhibitor can be α-(1-methylethyl)-α-[4-(trifluoromethoxy)phenyl]-5-pyrimidinemethanol (flurprimidol), and flurprimidol can be applied to the turf grass at a rate from 0.015 lbs/acre to 1.0 lbs/acre (e.g., 0.060 lbs/acre to 0.25 lbs/acre).

The Class B gibberellin biosynthesis inhibitor can be (±)-(R*,R*)-beta-[(4-chlorophenyl)methyl]-alpha-(1,1-dimethylethyl)-1H-1,2,4-triazole-1-ethanol (paclobutrazol), and the paclobutrazol can be applied to the turf grass at a rate from 0.025 lbs/acre to 1.50 lbs/acre (e.g., 0.10 lbs/acre to 0.25 lbs/acre).

The paraffinic oil can be applied to the turf grass at a rate from 1.0 oz/1000 square ft to 32 oz/1000 square ft.

The paraffinic oil can be applied to the turf grass at a rate from 4.0 oz/1000 square ft to 16 oz/1000 square ft.

The paraffinic oil and Class B gibberellin biosynthesis inhibitor can be applied to the plant in a weight ratio of Class B gibberellin biosynthesis inhibitor to paraffinic oil of from 1:5000 to 1:5.

The fungal pathogen can be a fungus that causes dollar spot, anthracnose, brown patch, crown rust, fusarium patch, gray leaf spot, large patch of zoysia, leaf spot, melting-out, necrotic ring, powdery mildew, red thread, grey snow mold, pink snow mold, southern blight, spring dead spot, summer patch, or a combination thereof in a turf grass.

The fungal pathogen can be Sclerotinia homoeocarpa, Colletotrichum cereale, Rhizoctonia solani, Microdochium nivale, Pyricularia grisea, Rhizoctonia solani, Drechslera spp., Biopolaris spp, Leptosphaeria korrae, Erysiphe graminis, Laetisaria fuciformis, Typhula ishikariensis, Typhula incarnate, Ophiosphaerella korrae, Magnaporthe poae, or a combination thereof.

The fungal pathogen can be a fungus that blights leaf tissue in a turf grass.

The fungal pathogen can be a fungus that causes dollar spot in a turf grass.

The fungal pathogen can be Sclerotinia homoeocarpa.

The turf grass can be one or more of: bentgrass, fine-leaf fescue, poa annua, tall fescue, seashore paspalum, Bermudagrass, zoysiagrass, bahiagrass, centipedegrass, or St. Augustinegrass.

The turf grass can be one or more of: bentgrass, bluegrass, ryegrass, fescue, bermudagrass, bahiagrass, zoysia, beachgrass, wheatgrass or carpetgrass.

The turf grass can be one or more of: creeping bentgrass, colonial bentgrass, perennial ryegrass, annual ryegrass, Kentucky bluegrass, common bermudagrass, hybrid bermudagrass, annual bluegrass, seashore paspalum, St. Augustinegrass, tall fescue, bahiagrass, zoysiagrass, centipedegrass, rough stalk bluegrass, buffalo grass, blue grama, or annual bentgrass.

The turf grass can be one or more of: creeping bentgrass or annual bluegrass.

The paraffinic oil and Class B gibberellin biosynthesis inhibitor exhibit a greater than additive effect in controlling a fungal pathogen of a plant.

The paraffinic oil and Class B gibberellin biosynthesis inhibitor exhibit a synergistic effect in controlling a fungal disease of a plant.

### DEFINITIONS

As used herein, the term “oil-in-water emulsion” refers to a mixture in which one of the paraffinic oil and water (e.g., the paraffinic oil) is dispersed as droplets in the other (e.g., the water). In some implementations, an oil-in-water emulsion is prepared by a process that includes combining the paraffinic oil, water, and any other components and the paraffinic oil and applying shear until the emulsion is obtained (typically a white milky color is indicative of the formation of an emulsion in the absence of any pigment; a green color is observed in the presence of a pigment). In other implementations, an oil-in-water emulsion is prepared by a process that includes combining the paraffinic oil, water, and any other components in the mixing tank and sprayed through the nozzle of a spray gun.

As used herein, the term “regulate the growth of a plant” (and the like) means to reduce, impede, suppress, delay, or otherwise slow the rate of growth and/or maturation of a plant(s) (e.g., turf grass), such that the rate of growth and/or maturation in the presence of the combinations described herein is less than the rate observed in the absence of any plant growth regulator (e.g., a Class B gibberellin biosynthesis inhibitor). Plant growth can include the growth of the leaves, stems, roots, and/or flowers of the plant. In some implementations, plant growth is associated with cell division or cell elongation.

Examples of regulating the growth of a plant can include (without limitation): reducing turf grass shoot growth, reducing turf grass leaf growth, reducing stem internode elongation, reducing turf grass vertical growth, reducing mowing frequency, reducing clippings production, reducing or reducing potential for scalping of turf grass, suppressing seedhead production or formation, reducing seedhead stalk height, selectively suppressing growth of a turf grass species, cultivar, or variety over a more desired turf grass species, cultivar, or variety (such as selective suppression of annual bluegrass over a perennial turf grass, such as suppression of annual bluegrass over a perennial cool-season turf grass, e.g., bentgrass, Kentucky bluegrass, or perennial ryegrass; suppression of poa annua in bentgrass), enhancing establishment of cool-season turf grasses during overseeding, such as enhancing establishment of ryegrass overseeding in bermudagrass, and reducing edging or banding of turf grass near, for example, sidewalks, curbs, parking lots, driveways, or trees (or any combination thereof).

Some growth regulator effects can be measured by collecting and weighing clippings as described in the Examples section.

As used herein, the term “reduce the phytotoxic effect of the applied Class B gibberellin biosynthesis inhibitor” (and the like) means to control, lessen, decrease, counteract, protect against, suppress, minimize, diminish or alleviate a phytotoxic effect of the Class B gibberellin biosynthesis inhibitor (such as one that is observed in the presence of the Class B gibberellin biosynthesis inhibitor and in the absence of at least the paraffinic oil). As used herein, the terms “phytotoxic effect”, “phytotoxicity”, or the like, refer to an undesired harmful, lethal, toxic, damaging, poisonous, or otherwise adverse, negative, detrimental, or destructive effect of the Class B gibberellin biosynthesis inhibitor on the plant, e.g., plant injury, plant damage, decline in plant quality, or plant death.

In some implementations, this term means that a plant (e.g., turf grass) treated with the combinations described herein exhibits a turf quality of greater than or equal to 6 after application of the combinations described herein (or after each application when the combinations described herein are applied more than once to the same area of turf grass).

As used herein, the term “control a fungal pathogen of a plant” or “control a disease caused by a fungal pathogen” (and the like) means to diminish, ameliorate, or stabilize the disease and/or any other existing unwanted condition or side effect that is caused by the association of a fungal pathogen with the plant.

As used herein, the term “turf grass” refers to a cultivated grass that provides groundcover, for example a turf or lawn that is periodically cut or mowed to maintain a consistent height. Grasses belong to the Poaceae family, which is subdivided into six subfamilies, three of which include common turf grasses: the Festucoideae subfamily of cool-season turf grasses; and the Panicoideae and Eragrostoideae subfamiles of warm-season turf grasses. A limited number of species are in widespread use as turf grasses, generally meeting the criteria of forming uniform soil coverage and tolerating mowing and traffic. In general, turf grasses have a compressed crown that facilitates mowing without cutting off the growing point. In the present context, the term “turf grass” includes areas in which one or more grass species are cultivated to form relatively uniform soil coverage, including blends that are a combination of differing cultivars of the same species, or mixtures that are a combination of differing species and/or cultivars.

Examples of turf grasses include, without limitation:
bluegrasses (Poa spp.), such as kentucky bluegrass (Poa pratensis), rough bluegrass (Poa trivialis), Canada bluegrass (Poa compressa), annual bluegrass (Poa annua), upland bluegrass (Poa glaucantha), wood bluegrass (Poa nemoralis), bulbous bluegrass (Poa bulbosa), Big Bluegrass (Poa ampla), Canby Bluegrass (Poa canbyi), Pine Bluegrass (Poa scabrella), Rough Bluegrass (Poa trivialis), Sandberg Bluegrass (Poa secunda);
the bentgrasses and Redtop (Agrostis spp.), such as creeping bentgrass (Agrostis palustris), colonial bentgrass (Agrostis capillaris), velvet bentgrass (Agrostis canina), South German Mixed Bentgrass (Agrostis spp. including Agrostis tenius, Agrostis canina, and Agrostis palustris), Redtop (Agrostis alba), Spike Bentgrass (Agrostis exerata);
the fescues (Festucu spp.), such as red fescue (Festuca rubra spp. rubra) creeping fescue (Festuca rubra), chewings fescue (Festuca rubra commutata), sheep fescue (Festuca ovina var. ovina), hard fescue (Festuca longifolia), hair fescue (Festucu capillata), tall fescue (Festuca arundinacea), meadow fescue (Festuca elatior), Arizona Fescue (Festuca arizonica), Foxtail Fescue (Festuca megalura), Idaho Fescue (Festuca idahoensis), Molate Fescue (Fescue rubra);
the ryegrasses (Lolium spp.), such as annual ryegrass (Lolium multiflorum), perennial ryegrass (Lolium perenne), and italian ryegrass (Lolium multiflorum);
the wheatgrasses (Agropyron spp.), such as crested wheatgrass (Agropyron cristatum), desert wheatgrass (Agropyron desertorum), western wheatgrass (Agropyron smithii), Intermediate Wheatgrass (Agropyron intermedium), Pubescent Wheatgrass (Agropyron trichophorum), Slender Wheatgrass (Agropyron trachycaulum), Streambank Wheatgrass (Agropyron riparium), Tall Wheatgrass (Agropyron elongatum), and Bluebunch Wheatgrass (Agropyron spicatum);
beachgrass (Ammophila breviligulata);
Brome grasses (Bromus spp.), such as Arizona Brome (Bromus arizonicus), California Brome (Bromus carinatus), Meadow Brome (Bromus biebersteinii), Mountain Brome (Bromus marginatus), Red Brome (Bromus rubens), and smooth bromegrass (Bromus inermis);
cattails such as Timothy (Phleum pratense), and sand cattail (Phleum subulatum); orchardgrass (Dactylis glomerata);
Alkaligrass (Puccinellia distans);
crested dog's-tail (Cynosurus cristatus);
Bermudagrass (Cynodon spp. such as Cynodon dactylon); hybrid bermudagrass such as tifdwarf bermudagrass, ultradwarf bermudagrass, tifgreen bermudagrass, tifsport bermudagrass, GN-1 bermudagrass, Ormond bermudagrass, and tifway bermudagrass;
Zoysiagrasses (Zoysia spp.) such as Zoysia japonica, Zoysia matrella, and Zoysia tenuifolia;
St. Augustinegrass (Stenotaphrum secundatum) such as Bitter Blue St. Augustinegrass, Seville St. Augustinegrass, Floratam St. Augustinegrass, Floralawn St. Augustinegrass, Floratine St. Augustinegrass, Raleigh St. Augustinegrass, and Texas Common St. Augustinegrass;
Centipedegrass (Eremochloa ophiuroides);
Carpetgrass (Axonopus fissifolius);
Bahiagrass (Paspalum notatum);
Kikuyugrass (Pennisetum clandestinum);
Buffalograss (Buchloe dactyloids);
Seashore paspalum (Paspalum vaginatum); Blue Grama (Bouteloua gracilis); Black Grama (Bouteloua eriopoda); Sideoats Grama (Bouteloua curtipendula);
Sporobolus spp., such as Alkali Sacaton (Sporobolus airiodes);
Sand Dropseed (Sporobolus cryptandrus), and Prairie Dropseed (Sporobolus heterolepis);
Hordeum spp., such as California Barley (Hordeum californicum),
Common Barley (Hordeum vulgare), and Meadow Barley (Hordeum brachyantherum);
Alopecurus spp., such as Creeping Foxtail (Alopecurus arundinaceaus), and Meadow Foxtail (Alopecurus pratensis);
Stipa spp., such as Needle & Thread (Stipa comata), Foothill Needlegrass (Stipa lepida), Green Needlegrass (Stipa viridula), Nodding Needlegrass (Stipa cernua), and Purple Needlegrass (Stipa pulchra);
Elymus spp., such as Blue Wildrye (Elymus glaucus), Canada Wildrye (Elymus Canadensis), Creeping Wildrye (Elymus triticoides), and Russian Wildrye (Elymus junceus);
Buffelgrass (Cenchrus ciliaris);
Big Quaking Grass (Briza maxima);
Big Bluestem (Andropogon gerardii),
Little Bluestem (Schizachyruim scoparium, and Sand Bluestem (Andropogon hallii);
Deergrass (Muhlenbergia rigens);
Eastern Gamagrass (Tripsacum dactyloides);
Galleta (Hilaria jamesii);
Tufted Hairgrass (Deschampsia caespitosa);
Indian Rice Grass (Oryzopsis hymenoides);
Indian Grass (Sorghastrum nutans);
Sand Lovegrass (Eragrostis trichodes); Weeping Lovegrass (Eragrostis curvula);
California Melic (Melica californica);
Prairie Junegrass (Koeleria pyramidata);
Prairie Sandreed (Calamovilfa longifolia);
Redtop (Agrostis alba);
Reed Canarygrass (Phalaris arundinacea);
Sloughgrass (Spartina pectinata);
Green Sprangletop (Leptochloa dubia);
Bottlebush Squirreltail (Sitanion hystrix);
Panicum Switchgrass (virgatum); and
Purple Threeawn (Aristida purpurea).

The term “alkyl” refers to substituted or unsubstituted saturated hydrocarbon groups, including straight-chain alkyl and branched-chain alkyl groups.

The terms “alkenyl” and “alkynyl” refer to substituted or unsubstituted unsaturated aliphatic groups analogous in length and possible substitution to the alkyls described above, but that contain at least one double or triple bond, respectively.

The term “aralkyl”, as used herein, refers to a C₁₋₆alkyl group substituted with an aryl group (e.g., phenyl).

The details of one or more implementations of the combinations and methods described herein are set forth in the accompanying description below. Other features and advantages of the combinations and methods described herein will be apparent from the description and drawings, and from the claims.

### DETAILED DESCRIPTION

This disclosure features combinations that include one or more paraffinic oils and one or more Class B gibberellin biosynthesis inhibitors. The combinations can further include (but are not limited to) one or more of the following: one or more emulsifiers, one or more pigments, one or more silicone surfactants, one or more anti-settling agents, and water. In some implementations, the combinations can be in the form of a single composition (e.g., which is contained within a storage pack or a vessel (e.g., a tank) suitable for applying the composition to a plant, e.g., turf grass). Typically, the composition is applied to a plant (e.g., turf grass) after dilution with water. In other implementations, the combinations can include two or more separately contained (e.g., packaged) compositions, each containing one or more of the above-mentioned components. Said compositions can be combined and applied to a plant (e.g., turf grass) with or without prior dilution with water; or each composition can be applied separately to the same plant (e.g., turf grass) either simultaneously or sequentially, and each typically after dilution with water. This disclosure also features methods of using the combinations for promoting health of a plant (e.g., turf grass) as well as methods of formulating combinations that include both oil and water as oil-in-water (O/W) emulsions.

I. Components

[A] Class B Gibberellin Biosynthesis Inhibitor

Class B gibberellin biosynthesis inhibitors are plant growth regulators that reduce the rate of growth or maturation of a plant (e.g., turf grass). The combinations include isomers such as geometrical isomers, optical isomers based on asymmetric carbon, stereoisomers and tautomers of the compounds described herein and are not limited by the description of the formulae illustrated for the sake of convenience.

[1]

In some implementations, the Class B gibberellin biosynthesis inhibitor has formula V:

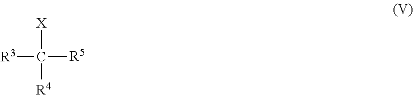

wherein:

R³ is 2-pyrazinyl, 3-pyridyl, or 5-pyrimidinyl;

R⁴ is phenyl, pyridyl, C₁-C₁₂ alkyl, or C₃-C₈ cycloalkyl;

R⁵ is trifluoromethoxyphenyl, tetrafluoroethoxyphenyl, pentafluoroethoxyphenyl, 3,4-(difluoromethylenedioxy)phenyl, or 2,2,4,4-tetrafluoro-1,3-benzodioxanyl; and

X is hydrogen, hydroxy, lower alkoxy, lower alkylthio, or lower alkanoyloxy; or an acid addition salt thereof.

Examples of such compounds are described in in U.S. Pat. No. 4,002,628.

In certain implementations, the compound of formula V is Flurprimidol (CAS No. 56425-91-3; Molecular Formula: C₁₅H₁₅F₃N₂O₂), which as the following chemical structure:

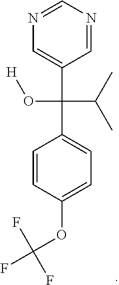 [SMILES: CC(C)C(O)(c1ccc(OC(F)(F)F)cc1)c1cncnc1]

Flurprimidol is also known by the following synonyms:
(RS)-2-methyl-1-pyrimidin-5-yl-1-(4-trifluoromethoxyphenyl)propan-1-ol;
α-(1-methylethyl)-α-[4-(trifluoromethoxy)phenyl]-5-pyrimidinemethanol;
alpha-isopropyl-alpha-(p-(trifluoromethoxy)phenyl)-5-pyrimidinemethanol;
(RS)-2-methyl-1-pyrimidin-5-yl-1-(4-trifluoromethoxy)phenylpropan-2-ol;
alpha-(1-methylethyl)-alpha-(4-(trifluoromethoxy)phenyl)-5-pyrimidinemethanol;
5-pyrimidinemethanol, alpha-(1-methylethyl)-alpha-(4-(trifluoromethoxy) phenyl)-; and
2-methyl-1-pyrimidin-5-yl-1-[4-(trifluoromethoxy)phenyl] propan-1-ol.

Flurprimidol can be obtained commercially, for example, as a product identified as Cutless™ (available from SePRO Corporation, Carmel, Ind., USA); or synthesized using conventional techniques known in the art of synthetic organic chemistry.

[2]

In some implementations, the Class B gibberellin biosynthesis inhibitor has formula VI:

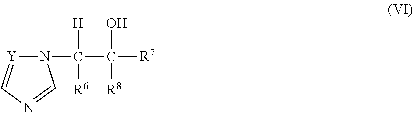

wherein:

R⁶ is alkenyl, alkynyl, or optionally substituted aralkyl;

Y is ═N— or ═C—;

R⁷ is cycloalkyl, alkyl, or haloalkyl; and

R⁸ is hydrogen, methyl or alkenyl;

or an ester, an ether, an acid addition salt or a metal complex thereof.

Examples of such compounds are described in in U.S. Pat. No. 4,243,405.

In certain implementations, the compound of formula VI is Paclobutrazol (CAS No. 76738-62-0; Molecular Formula: C₁₅H₂₀ClN₃O), which as the following chemical structure:

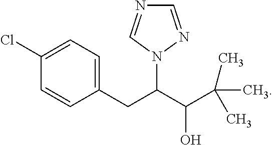 [SMILES: CC(C)(C)C(O)C(Cc1ccc(Cl)cc1)n1cncn1]

Paclobutrazol is also known by the following synonyms:
(+/−)-R*,R*-beta-((4-chlorophenyl)methyl)-alpha-(1,1-dimethylethyl)-1H-1,2,4-triazol-1-ethanol;
(R*,R*)-beta-[(4-chlorophenyl)methyl]-alpha(1,1-dimethylethyl)-1H-1,2,4-triazole-1-ethanol;
(R*,R*)-β-[(4-chlorophenyl)methyl]-α-(1,1-dimethylethyl)-1H-1,2,4-triazole-1-ethanol;
1H-1,2,4-Triazole-1-ethanol, b-[(4-chlorophenyl)methyl]-α-(1,1-dimethylethyl)-, (R*,R*)-(+−)-;
α-tert-butyl-β-(4-chlorobenzyl)-1H-1,2,4-triazole-1-ethanol;
(2RS,3RS)-1-(4-chlorophenyl)-4,4-dimethyl-2-(1H-1,2,4-triazol-1-yl)-pentane-3-ol;
(αR,βR)-rel-β-[(4-chlorophenyl)methyl]-α-(1,1-dimethylethyl)-1H-1,2,4-triazole-1-ethanol;
1-(4-chloro-phenyl)-4,4-dimethyl-2-[1,2,4]triazol-1-yl-pentan-3-ol; and
(R*,R*)-(+/−)-β-[(4-chlorophenyl)methyl]-α-(1,1-dimethylethyl)-1H-1,2,4-triazole-1-ethanol;

Paclobutrazol can be obtained commercially, for example, as a product identified as Trimmit™ (available from Syngenta Crop Protection, Inc., Greensboro, N.C., USA); or synthesized using conventional techniques known in the art of synthetic organic chemistry.

[B] Paraffinic Oil

The paraffinic oil confers properties (e.g., fungicidal properties) that are useful for promoting the health of a plant (e.g., turf grass). While not wishing to be bound by theory, it is believed that the paraffinic oil is able to provoke an induced systemic resistance (ISR) response, a systemic acquired resistance (SAR), or other defense response in a plant.

[1]

In some implementations, the paraffinic oil includes an oil enriched in paraffin.

In certain implementations, the paraffinic oil includes a paraffin having from 12 carbon atoms to 50 carbon atoms (e.g., 12 carbon atoms to 40 carbon atoms, 16 carbon atoms to 35 carbon atoms, 12 carbon atoms to 21 carbon atoms; e.g., 16 carbon atoms to 35 carbon atoms).

In certain implementations, the paraffinic oil includes a paraffin having an average number of carbon atoms that is less than or equal to about 20 (e.g., 16).

In certain implementations, the paraffinic oil includes a paraffin having an average number of carbon atoms of from 16 to 30 e.g., 23 or 27).

In certain implementations, the paraffinic oil includes a paraffin having from 16 carbon atoms to 35 carbon atoms and an average number of carbon atoms of 23.

In certain implementations, the paraffin is an isoparaffin (e.g., a synthetic isoparaffin manufactured from two-stage Severe Hydrocracking/Hydroisomerization process).

In some implementations, a paraffin is present in the paraffinic oil in an amount, that is at least 80% (e.g., at least 90%, at least 99%).

[2]

In some implementations, the paraffinic oil has been refined to remove compounds that are associated with plant injury, for example, aromatic compounds or compounds containing sulfur, nitrogen, or oxygen. In certain implementations, the paraffinic oil includes relatively low levels of aromatic compounds and/or compounds containing sulfur, nitrogen, or oxygen, e.g., less than 10 weight percent (less than 5 weight percent, less than 2 weight percent, less than 0.5 weight percent) of aromatic compounds and/or compounds containing sulfur, nitrogen, or oxygen.

[3]

Non-limiting examples of suitable paraffinic oils include, HT60, HT100, High Flash Jet, LSRD, and N65DW (available from Petro-Canada, Calgary, AB, Canada).

[C] Emulsifier

In some implementations, the combinations include both paraffinic oil, emulsifier, and water. It can be advantageous to store and/or apply such combinations as oil-in-water (O/W) emulsions.

Emulsions tend to be thermodynamically unstable due to excess free energy associated with the surface of the dispersed droplets such that the particles tend to flocculate (clumping together of dispersed droplets or particles) and subsequently coalesce (fusing together of agglomerates into a larger drop or droplets) to decrease the surface energy. If these droplets fuse, the emulsion will “break” (i.e., the phases will separate) destroying the emulsion, which in some cases can be detrimental to the storage shelf-life of the combinations. While not wishing to be bound by theory, it is believed that the addition of one (or more) emulsifying agents or emulsifiers can prevent or slow the “breaking” of an emulsion. As the skilled artisan will appreciate, the type and concentration of a particular emulsifying agent will depend, inter alfa, on the emulsion phase components and the desired result.

[1]

In some implementations, the emulsifier is a “fast break” or “quick break” emulsifier. While not wishing to be bound by theory, it is believed that a “fast break” or “quick break” emulsifier allows the paraffinic oil to be quickly released from the O/W emulsion upon application to the turfgrass for contact, e.g., with a fungal pathogen. When a “fast break” or “quick break” emulsifier is present in a suitable amount (for example a selected proportion or ratio with respect to the paraffinic oil), the resulting “fast break” or “quick break” O/W emulsion quickly releases the oil phase upon application to the turfgrass. As such, there is less runoff of the O/W emulsion from the grass blades (as compared to more stable O/W emulsions) resulting in more oil adhering to the turfgrass for a longer period of time to more effectively contact and control, e.g., associated fungal pathogen. In certain implementations, the oil phase resides on the turfgrass for a period of not less than one hour. In certain implementations, the oil phase resides on the turfgrass for a period of from not less than 1 hour but not more than 30 days. In certain implementations, the “fast break” or “quick break” emulsion may be, for example, an emulsion having an oil phase that, after mixing with water, is reconstituted in 0.5 to 15 minutes according to the following test:
1. Fill 100 mL graduated cylinder with tap water.
2. Add 1 mL of emulsified oil.
3. Invert graduated cylinder 5 times.
4. Using a stop watch and human observation, measure how long it takes for the oil phase to reconstitute after inversion (step 3).

In some implementations, the oil phase is reconstituted in from 2 minutes to 5 minutes according to the test described above. In some instances, the “fast break” or “quick break” property of the O/W emulsion is balanced with the need to provide an O/W emulsion with a suitable shelf life under suitable storing conditions, and for a suitable timeframe.

[2]

In some implementations, the emulsifier is (or includes) one (or more of the following) a natural or synthetic alcohol ethoxylate, an alcohol alkoxylate, an alkyl polysaccharide, a glycerol oleate, a polyoxyethylene-polyoxypropylene block copolymer, an alkyl phenol ethoxylate, a polymeric surfactant, a polyethylene glycol, a sorbitan fatty acid ester ethoxylate, or any combination thereof.

In certain implementations, the emulsifier is (or includes) a natural or synthetic alcohol ethoxylate, a polymeric surfactant, a sorbitan fatty acid ester, or any combination thereof.

In certain implementations, the natural or synthetic alcohol ethoxylate is a polyoxyethylene (4 to 12) lauryl ether (C12), polyoxyethylene (10) cetyl ether (C16), polyoxyethylene (10) stearyl ether (C18), polyoxyethylene (10) oleyl ether (C18 mono-unsaturated), a polyoxyethylene (2 to 11) C12-C15 alcohol, a polyoxyethylene (3 to 9) C11-C14 alcohol, a polyoxyethylene (9) C12-C14 alcohol, a polyoxyethylene (11) C16-C18 alcohol, a polyoxyethylene (20) C12-C15 alcohol, or any combination thereof. For example, the natural or synthetic alcohol ethoxylate can be a polyoxyethylene (4 to 7) lauryl ether (C12), polyoxyethylene (10) cetyl ether (C16), a polyoxyethylene (2 to 11) C12-C15 alcohol, a polyoxyethylene (3 to 9) C11-C14 alcohol, a polyoxyethylene (9) C12-C14 alcohol, or any combination thereof. As another example, the alcohol alkoxylate can be a butyl ether polyoxyethylene/polyoxypropylene block copolymer.

In certain implementations, the emulsifier is (or includes) an alkyl polysaccharide, e.g., a C8-C11 alkylpolysaccharide or any combination thereof.

In certain implementations, the emulsifier is (or includes) a glycerol oleate, e.g., a glycerol mono-, di-, tri-oleate, or any combination thereof.

In certain implementations, the emulsifier is (or includes) a polyoxyethylene-polyoxypropylene block copolymer, e.g., a polyoxyethylene-polyoxypropylene block copolymer having a molecular weight (or relative molar mass) of from 1100 to about 11400 and 10 to 80% (ethylene oxide) Ea

In certain implementations, the emulsifier is (or includes) an alkyl phenol ethoxylate, e.g., a nonyl phenol ethoxylate, a dodecyl phenol ethoxylate, or any combination thereof. For example, the nonyl phenol ethoxylate can be a polyoxyethylene (2 to 8) nonylphenol.

In certain implementations, the emulsifier is (or includes) a polymeric surfactant, e.g., a graft copolymer, a random copolymer, or any combination thereof. For example, the graft copolymer can be a polymethacrylic acid and acrylate with polyoxyethylene chains. For example, the random copolymer can be a random copolymer having ester and ether groups.

In certain implementations, the emulsifier is (or includes) a polyethylene glycol, e.g., a polyethylene glycol having a molecular weight (“MW”) (or relative molar mass) of from 200 to 8000, e.g., MW 400 PEG dioleate; or MW600 PEG dioleate.

In certain implementations, the emulsifier is (or includes) a sorbitan fatty acid ester ethoxylate, e.g., polyoxyethylene (20) sorbitan tristearate, polyoxyethylene (20) sorbitan monooleate, polyoxyethylene (5) sorbitan monooleate, polyoxyethylene (20) sorbitan trioleate, or any combination thereof. For example, the sorbitan fatty acid ester can be a sorbitan tristearate, a sorbitan triolate, or any combination thereof.

In certain implementations, the emulsifier is (or includes) an alkyl phenol ethoxylate, a mixture of an ethoxylated alcohol and a glycerol oleate, or any combination thereof.

In certain implementations, the emulsifier is (or includes) a mixture of an ethoxylated alcohol and a glycerol oleate, e.g.: a C10 to C16 alcohol ethoxylate and a glycerol oleate combination; or polyoxyethylene lauryl ether, C10 to C16 alcohol ethoxylates, and glycerol oleate; or ethoxylated alcohols having primary C5-C20 carbon chains with an average of about 2 to about 7 ethoxylation groups, and a glycerol oleate; or a polyoxyethylene (11) C16-18 alcohol.

In certain implementations, the emulsifier is (or includes) a sorbitan tristearate.

Non-limiting examples of suitable emulsifiers include AL3149 (available from Uniqema), AL3313 (available from Uniqema), PC Emuls Green (available from Petro-Canada, Calgary, AB, Canada), Lutensol™ AT11 (available from BASF), SPAN65 (available from Uniqema), and S-MAZ™ 65K (available from BASF).

[3]

In some implementations, the weight ratio of the paraffinic oil to the emulsifier is from 10:1 to 500:1 (e.g., from 98:2 to 99.9:0.1, from 98:2 to 99.5:0.5). By way of example, the weight ratio of the paraffinic oil to the emulsifier can be 95:5, 98:2, 98.5:1.5, 99:1, 99.5:0.5

[D] Pigment

In some implementations, the combinations can include one (or more) pigments. The pigments can provide color to the plant being treated (e.g., turf grass) and/or in some implementations, the pigment(s) and the paraffinic oil can exhibit a greater than additive effect in promoting the health of a plant (e.g., controlling a fungal pathogen of a plant; see, for example, WO 2009/155693).

In some implementations, the pigment is a water-based pigment dispersion.

In some implementations, the pigment is an oil-based pigment dispersion.

In some implementations, the pigment is a phthalocyanine compound.

In certain implementations, the pigment is a metal-free phthalocyanine compound. In certain implementations, the pigment is a halogenated, metal-free phthalocyanine, e.g., a polychlorinated metal-free phthalocyanine.

In certain implementations, the pigment is a metal phthalocyanine compound.

In certain implementations, the pigment is a copper phthalocyanine.

In certain implementations, the copper phthalocyanine is a non-halogenated copper phthalocyanine, e.g., a nonchlorinated copper phthalocyanine. As an example, the pigment can be Phthalocyanine Blue BN (CAS 147-14-8).

In certain implementations, the copper phthalocyanine is a halogenated copper phthalocyanine. As an example, the pigment can be Phthalocyanine Green 6G (CAS 14302-13-7). As another example, the pigment can be polychlorinated (Cu II) phthalocyanine, such as Phthalocyanine Green G (CAS 1328-45-6 and 1328-53-6).

Non-limiting examples of suitable pigments include Sunsperse™ Green 7 (Pigment Green 7 dispersed in water, available from Sun Chemical Corp. Performance Pigments Cincinnati, Ohio, USA), Sunsperse™ EXP 006-102 and 006-95B (Pigment Green 7 dispersed in oil, available from Sun Chemical Corp. Performance Pigments, Cincinnati, Ohio, USA), and Pigment Green 7 powder (available from Hercules Exports, Mumbai, India).

[E] Silicone Surfactant

In some implementations, it can be advantageous to further include one (or more) silicone surfactants in combinations that further include one or more pigments.

[1]

In some implementations, the silicone surfactant is (or includes) a silicone polyether.

In certain implementations, the silicone surfactant is (or includes) a silicone polyether having a suitable alkoxy group with hydrogen end groups (H-capped), methyl end groups (CH₃-capped), or acetyl end groups (COCH₃-capped). In certain implementations, the silicone surfactant is (or includes) a trisiloxane having a suitable alkoxy group with hydrogen end groups (H-capped), methyl end groups (CH₃-capped), or acetyl end groups (COCH₃-capped).

In certain implementations, the silicone surfactant is (or includes) a silicone polyether of the formula I:

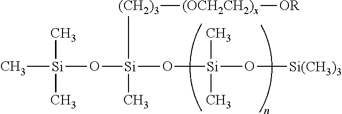

in which R is H, CH₃ or COCH₃; x is 1 to 24; and n is 0 or ≧1.

In certain implementations, the silicone surfactant is (or includes) a silicone polyether of the formula I wherein R=H; x=1 to 24; and n=0; e.g., a silicone polyether of the formula I wherein n=0; x=1-24; the average x=8-10; and R=H.

In certain implementations, the silicone surfactant is (or includes) a silicone polyether of the formula I wherein R=H; x=1 to 24; and n≧1.

In certain implementations, the silicone surfactant is (or includes) a silicone polyether of the formula I wherein R=CH₃; x=1 to 24; and n=0.

In certain implementations, the silicone surfactant is (or includes) a silicone polyether of the formula I wherein R=CH₃; x=1 to 24; and n≧1.

In certain implementations, the silicone surfactant is (or includes) a silicone polyether of the formula I wherein R=COCH₃; x=1 to 24; and n=0; e.g., a silicone polyether of the formula I wherein n=0; x=1-24, the average x=8-10; and R=COCH₃.

In certain implementations, the silicone surfactant is (or includes) a silicone polyether of the formula I wherein R=COCH₃; x=1 to 24; and n≧1.

In certain implementations, the silicone surfactant is (or includes) an H-capped dimethyl methyl(polyethylene oxide) silicone polymer; e.g., having a molecular weight (or relative molar mass) from 200 to 6000.

In certain implementations, the silicone surfactant is (or includes) a silicone polyether of the formula II:

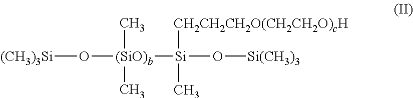

wherein c=2-16; and b=2-70. In certain implementations, the average b=44. In certain implementations, the average c=10. In certain implementations, the average b=44, and the average c=10.

In certain implementations, the silicone surfactant is (or includes) an H-capped trisiloxane, such as a silicone polyether of the formula III:

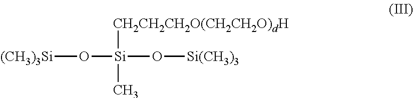

wherein d=1-24. In certain implementations, d=1-20. In certain implementations, the average d=8-10 (e.g., 8).

In certain implementations, the silicone surfactant is (or includes) a silicone copolyol, containing a hydrogen end group and one pendant polyethylene oxide group and has an average molecular weight between about 600 to about 1000 Daltons. In certain implementations, the silicone surfactant is (or includes) a trisiloxane with an ethoxylated alkyl group having a hydrogen end group (H-End); e.g., having a number of ethoxylation groups in the range of 1-20. In certain implementations, the silicone surfactant the silicone surfactant is (or includes) a methyl(propylhydroxide, ethoxylated) bis(trimethylsiloxy) silane; e.g., a dimethyl, methyl(polyethylene oxide) silicone polymer.

[2]

In some implementations, commercial preparations of the silicone surfactants may or may not contain small amounts of polyethylene glycols (PEG) or other low molecular weight polydimethyl siloxanes (PDMS).

In some implementations, the silicone surfactant further includes a polyethylene glycol.

In certain implementations, the polyethylene glycol is (or includes) a polyethylene glycol of the formula IV:

R¹—O—(CH₂CH₂O)_{f}—R²

wherein R¹=H or CH₂═CH—CH₂ or COCH₃; R²=H or CH₂═CH—CH₂ or COCH₃; and f≧1.

In certain implementations, the polyethylene glycol has a relatively low molecular weight, e.g. from 300 Daltons to 1500 Daltons. In certain implementations, the polyethylene glycol is a low molecular weight polyethylene glycol allyl ether, such as a low molecular weight polyethylene glycol mono-allyl ether having an average molecular of from about 300 to about 600 Daltons and having from 1 to 20 moles of ethylene glycol with an average ethylene oxide unit (EO) of 8 to 10.

In certain implementations, the polyethylene glycol is (or includes) a polyethylene glycol of the formula IV wherein R¹=CH₂═CH—CH₂, R²=H, and f=1-20 with an average f=8, a polyethylene glycol of the formula IV wherein R¹=CH₂═CH—CH₂ or COCH₃, and R²=COCH₃, a polyethylene glycol of the formula IV wherein R¹=CH₂═CH—CH₂, and R²=H, or any combination thereof.

In certain implementations, the polyethylene glycol is (or includes) a polyethylene glycol of the formula IV wherein R¹=CH₂═CH—CH₂ or COCH₃, and R²=COCH₃, a polyethylene glycol of the formula IV wherein R¹=CH₂═CH—CH₂, and R²=H, or any combination thereof.

In certain implementations, the polyethylene glycol is (or includes) a polyethylene glycol of the formula IV wherein R¹=CH₂═CH—CH₂, R²=H, and f=1-20 with an average f=8.

In certain implementations, the polyethylene glycol is (or includes) a polyethylene glycol of the formula IV wherein R¹=CH₂═CH—CH₂ or COCH₃, and R²=COCH₃.

In certain implementations, the polyethylene glycol is (or includes) a polyethylene glycol of the formula IV wherein R¹=CH₂═CH—CH₂, and R²=H.

Non-limiting examples of suitable polyethylene glycols may include Polyglykol A500 (available from Clariant).

In certain implementations, the silicone surfactant includes from 10 to 30 weight percent of a polyethylene glycol as described anywhere herein.

[3]

Non-limiting examples of suitable silicone surfactants may include Sylgard™ 309 (available from Dow Corning, Midland, Mich., USA), Silfsurf™ A008-UP (available from Siltech Corp. Toronto, ON, Canada), Lambent MFF 199 SW (available from Lambent Technologies Corp., Gurnee, Ill., USA), and Lambent MFF 159-100 (available from Lambent Technologies Corp., Gurnee, Ill., USA).

[F] Anti-Settling Agent

In some implementations, the combination can include one (or more) “anti-settling agents,” which reduce the likelihood of having solids suspended in a dispersion from settling out under the influence of gravity.

In some implementations, the anti-setting agent is (or includes) a metal oxide and/or an organically modified clay.

In some implementations, the anti-setting agent is (or includes) a metal oxide.

In certain implementations, the anti-setting agent is (or includes) a fumed metal oxide and/or a precipitated metal oxide.

In certain implementations, the anti-setting agent is (or includes) one or more of the following forms of silica: precipitated silica (e.g., an untreated, precipitated silica) or fumed silica (e.g., an untreated, fumed silica). As used herein, the term “untreated fumed silica”, or the like, is used to refer to a hydrophilic fumed silica. As used herein, the term “treated fumed silica”, or the like, is used to refer to a hydrophobic fumed silica.

In some implementations, the anti-settling agent is (or includes) an organically modified clay. In certain implementations, the anti-setting agent is (or includes) one or more of the following organically modified clays: an organically modified smectite clay, an organically modified hectorite clay, an organically modified bentonite clay, an organically modified montmorillonite clay and an organically modified attapulgite clay.

In certain implementations, the organically modified clay is activated by a chemical activator.

In certain implementations, the chemical activator includes a low-molecular-weight polar organic compound, e.g., a least one compound selected from the group consisting of a low-molecular weight ketone, a low-molecular weight alcohol and propylene carbonate.

In certain implementations, the chemical activator includes water and at least one compound selected from the group consisting of a low-molecular weight ketone, a low-molecular weight alcohol and propylene carbonate.

In certain implementations, the chemical activator includes a low-molecular weight ketone; or a low-molecular weight ketone and water (such as a low molecular weight ketone and water in a weight ratio of 95/5). An example of a low-molecular weight ketone is acetone.

In certain implementations, the chemical activator includes a low-molecular weight alcohol; or a low-molecular weight alcohol and water (such as a low-molecular weight alcohol and water in a weight ratio of 95/5). Examples of low-molecular weight alcohols include methanol or ethanol.

In certain implementations, the chemical activator includes propylene carbonate; or propylene carbonate and water (such as, propylene carbonate and water in a weight ratio of 95/5).

[G] Water

In some implementations, the combinations can further include water.

In some implementations, the pigment is dispersed in water before it is added to the remaining components of the combination (typically water is 1:1 weight percent with pigment), resulting in, e.g., the presence of 3 parts per weight of water in the combination.

In some implementations, the combinations can further include water, e.g., as a diluent, e.g., as a diluent added prior to application of the combinations to a plant (e.g., a turfgrass).

In some implementations, the combinations can further include both sources of water described above.

In some implementations the water is distilled water and/or other waters having a low mineral electrolyte content.

[H] Other Components

In some implementations, the combinations further include one or more other components that are customary additives or adjuvants for the preparation of compositions in the field of turf or field crop protection and/or components that are inert (e.g., may not materially affect the activity and/or overall performance of the combinations) and/or one or more other active components (e.g., other fungicides). As an example, the combinations can further include customary additives or adjuvants that may be present in a commercially available Class B gibberellin biosynthesis inhibitor.

In some implementations, the combinations include only combinations of the components set forth is sections [A] through [G] above.

In certain implementations, the combinations do not include one or more other components that are customary additives or adjuvants for the preparation of compositions in the field of turf or field crop protection and/or components that are inert (e.g., may not materially affect the activity and/or overall performance of the combinations) and/or one or more other active components (e.g., other fungicides).

In certain implementations, the combinations are free of one or more other components that are customary additives or adjuvants for the preparation of compositions in the field of turf or field crop protection and/or components that are inert (e.g., may not materially affect the activity and/or overall performance of the combinations) and/or one or more other active components (e.g., other fungicides); (e.g., the combinations contain less than 5%, less than 4%, less than 3%, less than 2%, less than 1% (w/w or w/v) of one or more other components that are customary additives or adjuvants for the preparation of compositions in the field of turf or field crop protection and/or components that are inert (e.g., may not materially affect the activity and/or overall performance of the combinations) and/or one or more other active components (e.g., other fungicides)).

In some embodiments, the combinations are substantially free of one or more other components that are customary additives or adjuvants for the preparation of compositions in the field of turf or field crop protection and/or components that are inert (e.g., may not materially affect the activity and/or overall performance of the combinations) and/or one or more other active components (e.g., other fungicides) (e.g., the combinations contain less than 0.5%, less than 0.2, less than 0.1, less than 0.05% (w/w or w/v), do not include a detectable amount of one or more other components that are customary additives or adjuvants for the preparation of compositions in the field of turf or field crop protection and/or components that are inert (e.g., may not materially affect the activity and/or overall performance of the combinations) and/or one or more other active components (e.g., other fungicides)).

II. Non-Limiting Combinations of Components

[A] Combinations that Include a Single Composition

[1]

In some implementations, the combinations can be in the form of a single composition (e.g., contained within a storage pack or a vessel suitable for applying the composition to a plant, e.g., turf grass). These compositions are sometimes referred to herein (without limitation, e.g., as to quantity or application mode) as a 1-pack formulations or concentrates in the absence of water for dilution.

In some implementations, the composition includes:

(i) one (or more) paraffinic oils, which can include any one or more of the features described in any one or more of sections [I][B][1], [I][B][2], and [I][B][3] above; and

(ii) one (or more) Class B gibberellin biosynthesis inhibitors, which can include any one or more of the features described in any one or more of sections [I][A][1] and/or [I][A][2] (e.g., the Class B gibberellin biosynthesis inhibitor is α-(1-methylethyl)-α-[4-(trifluoromethoxy)phenyl]-5-pyrimidinemethanol (flurprimidol) and/or the Class B gibberellin biosynthesis inhibitor is (±)-(R*,R*)-beta-[(4-chlorophenyl)methyl]-alpha-(1,1-dimethylethyl)-1H-1,2,4-triazole-1-ethanol (paclobutrazol)).

In some implementations, the composition further includes (but is not limited to) one or more of the following:

(iii) one (or more) emulsifiers, which can include any one or more of the features described in any one or more of sections [I][C][1], [I][C][2], and [I][C][3] above;

(iv) one (or more) pigments which can include any one or more of the features described in section [I][D] above;

(v) one (or more) silicone surfactants, which can include any one or more of the features described in any one or more of sections [I][E][1], [I][E][2], and [I][E][3] above;

(vi) one (or more) anti-settling agents, which can include any one or more of the features described in section [I][D] above; and

(vii) one (or more) components described in section [I][H].

In some implementations, the composition includes (i), (ii), and (iii) above.

In some implementations, the composition includes (i), (ii), (iii), and (iv) above.

In some implementations, the composition includes (i), (ii), (iii), (iv), and (v) above.

In some implementations, the composition includes (i), (ii), (iii), (iv), (v), and (vi) above.

In some implementations, the composition includes (i), (ii), (iii), (iv), (v), (vi), and (vii) above.

[2] Concentrates

In some of the implementations described in section [II][A][1], one or more of the following applies:

(2-a) the weight ratio of paraffinic oil to the emulsifier is from 10:1 to 500:1 (e.g., from 45:1 to 55:1, e.g., 49:1, 50:1);

(2-b) the weight ratio of paraffinic oil to the pigment is from 5:1 to 100:1 (e.g., from 25:1 to 35:1, e.g., 28:1, 30:1);

(2-c) the weight ratio of pigment to the silicone surfactant is from 2:1 to 50:1 (e.g., from 3:1 to 6:1, e.g., 4.5:1);

(2-d) the weight ratio of paraffinic oil to the Class B gibberellin biosynthesis inhibitor is from 5:1 to 5000:1 (e.g., from 100:1 to 160:1; from 90:1 to 120:1, e.g., 111:1, 110:1; from 130:1 to 150:1, e.g., 139:1, 140:1; in certain implementations, the weight ratio of paraffinic oil to a formula (V) Class B gibberellin biosynthesis inhibitor, such as flurprimidol, is from 90:1 to 120:1, e.g., 111:1, 110:1; in certain implementations, the weight ratio of paraffinic oil to a formula (VI) Class B gibberellin biosynthesis inhibitor, such as paclobutrazol is from 130:1 to 150:1, e.g., 139:1, 140:1).

In certain implementations, (2-a) applies; or (2-a), (2-b) and (2-c) apply; or (2-b), and (2-c) apply. In certain implementations, (2-d) further applies to any one of the above-listed combinations of (2-a), (2-b) and (2-c).

In some of the implementations described in section [II][A][1], one or more of the following applies:

(2-aa) the concentrate includes from 50 to 300 parts per weight (e.g., 200-300, e.g., 260; e.g., 50-150, e.g., 100) parts per weight of the paraffinic oil;

(2-bb) the concentrate includes from 1 to 10 parts per weight (e.g., 3-7, e.g., 5; e.g., 1-5, e.g., 1.9, e.g., 2) parts per weight of the emulsifier;

(2-cc) the concentrate includes from 1 to 15 parts per weight (e.g., 7-11, e.g., 9; e.g., 2-5, e.g., 3.5) parts per weight of the pigment;

(2-dd) the concentrate includes from 0.1 to 10 parts per weight (e.g., 0.5-1, e.g., 0.8, e.g., e.g., 2-5, e.g., 3.1) parts per weight of the silicone surfactant;

(2-ee) the concentrate includes from 0.5 to 20 parts per weight (e.g., 6-10, e.g., 8; e.g., 2-5, e.g., 3.1) parts per weight of the anti-settling agent; or

(2-ff) the concentrate includes from 0.1 to 10 parts per weight (e.g., 0.5-1, e.g., 0.8, e.g., e.g., 1-3, e.g., 2) parts per weight of the Class B gibberellin biosynthesis inhibitor.

In certain implementations, (2-aa) and (2-bb) apply; or (2-cc) and (2-dd) apply; or (2-aa), (2-bb), and (2-ff) apply; or (2-cc), (2-dd), and (2-ff) apply; or (2-aa), (2-bb), (2-cc), (2-dd), and (2-ff) apply. In certain implementations, (2-ee) further applies to each of the above-listed implementations.

In some implementations, the pigment is dispersed in compatible oil, e.g., a paraffinic oil, e.g., the same paraffinic oil as is used to provide the fungicidal properties as described herein, for addition to the other components of the combinations described herein. In certain implementations, a silicone surfactant and/or emulsifier and/or anti-settling agent can be included, e.g., to stabilize the pigment in the oil-based combination.

For example, polychlorinated Cu (II) phthalocyanine can be dispersed in a paraffinic oil, such as N65DW (available from Petro-Canada) to provide about 18% polychlorinated CU (II) phthalocyanine (SUNSPERSE® EXP 006-102, available from Sun Chemical Corp. Performance Pigments, Cincinnati, Ohio USA) prior to mixing with the remaining components. In certain implementations, a silicone surfactant and/or emulsifier and/or anti-settling agent can be included. While not wishing to be bound by theory, it is believed that the addition of these components can provide an intermolecular hydrophilic and lipophilic balance within the fungicidal formulation so as to substantially prevent the polychlorinated Cu (II) phthalocyanine from separating out of suspension during application, e.g., to a turf grass.

In some of the implementations described in section [II][A][1], the composition includes the components present in Civitas™ 1-pack and those present in either Trimmit™ or Cutless™.

[3]

In some of the implementations described in sections [II][A][1] and [II][A][2], the composition further includes water. In certain implementations, weight percent ratio of the undiluted composition to water is from 1:1 to 1:100 (e.g., from 1:50, 1:30, 1:20, 1:15, 1:10). In certain implementations, the weight percent of the paraffinic oil in the diluted compositions is from 2-5 weight percent (e.g., 2.5). In certain implementations, the composition is in the form of an oil in water emulsion as described anywhere herein.

In some implementations, the pigment is dispersed in water for addition to the other components of the combinations described herein. In certain implementations, a silicone surfactant and/or emulsifier and/or anti-settling agent can be included, e.g., to stabilize the pigment in the oil/water-based combination.

For example, polychlorinated Cu (II) phthalocyanine can be dispersed in a water to provide about 40% polychlorinated CU (II) phthalocyanine (SUNSPERSE® GREEN 7, available from Sun Chemical Corp. Performance Pigments, Cincinnati, Ohio USA) prior to mixing with the remaining components. In certain implementations, a silicone surfactant and/or emulsifier and/or anti-settling agent can be included. While not wishing to be bound by theory, it is believed that the addition of these components can provide an intermolecular network so as to substantially prevent the polychlorinated Cu (II) phthalocyanine from separating out of suspension during application, e.g., to a turf grass.

[B] Combinations that Include Two or More Compositions

[1]

In some implementations, the combinations include two or more separately contained (e.g., packaged) compositions, each containing one or more of the components described in sections [I][A]-[I][F] and [I][H]. These implementations are sometimes referred to (as appropriate and without limitation, e.g., as to quantity or application mode) as 2-pack and 3-pack formulations, compositions, or concentrates in the absence of water for dilution.

In some implementations, the combinations include a first and separately contained composition and a second and separately contained composition, in which:

(1) the first and separately contained composition includes:
one (or more) paraffinic oils, which can include any one or more of the features described in any one or more of sections [I][B][1], [I][B][2], and [I][B][3] above;
one (or more) Class B gibberellin biosynthesis inhibitors, which can include any one or more of the features described in any one or more of sections [I][A][1] and/or [I][A][2] (e.g., the Class B gibberellin biosynthesis inhibitor is α-(1-methylethyl)-α-[4-(trifluoromethoxy)phenyl]-5-pyrimidinemethanol (flurprimidol) and/or the Class B gibberellin biosynthesis inhibitor is (±)-(R*,R*)-beta-[(4-chlorophenyl)methyl]-alpha-(1,1-dimethylethyl)-1H-1,2,4-triazole-1-ethanol (paclobutrazol)); and
one (or more) emulsifiers, which can include any one or more of the features described in any one or more of sections [I][C][1], [I][C][2], and [I][C][3] above; and

(2) the second and separately contained composition includes:
one (or more) pigments, which can include any one or more of the features described in section [I][D] above and
one (or more) silicone surfactants, which can include any one or more of the features described in any one or more of sections [I][E][1], [I][E][2], and [I][E][3] above.

In some implementations, the combinations include a first and separately contained composition and a second and separately contained composition, in which:

(1) the first and separately contained composition includes:
one (or more) paraffinic oils, which can include any one or more of the features described in any one or more of sections [I][B][1], [I][B][2], and [I][B][3] above;
one (or more) emulsifiers, which can include any one or more of the features described in any one or more of sections [I][C][1], [I][C][2], and [I][C][3] above;
one (or more) pigments, which can include any one or more of the features described in section [I][D] above;
one (or more) silicone surfactants, which can include any one or more of the features described in any one or more of sections [I][E][1], [I][E][2], and [I][E][3] above; and
one (or more) anti-settling agents, which can include any one or more of the features described in section [I][D] above; and

(2) the second and separately contained composition includes:
one (or more) Class B gibberellin biosynthesis inhibitors, which can include any one or more of the features described in any one or more of sections [I][A][1] and/or [I][A][2] (e.g., the Class B gibberellin biosynthesis inhibitor is α-(1-methylethyl)-α-[4-(trifluoromethoxy)phenyl]-5-pyrimidinemethanol (flurprimidol) and/or the Class B gibberellin biosynthesis inhibitor is (±)-(R*,R*)-beta-[(4-chlorophenyl)methyl]-alpha-(1,1-dimethylethyl)-1H-1,2,4-triazole-1-ethanol (paclobutrazol));

In some implementations, the combinations include a first and separately contained composition and a second and separately contained composition, in which:

(1) the first and separately contained composition includes:
one (or more) paraffinic oils, which can include any one or more of the features described in any one or more of sections [I][B][1], [I][B][2], and [I][B][3] above; and
one (or more) emulsifiers, which can include any one or more of the features described in any one or more of sections [I][C][1], [I][C][2], and [I][C][3] above;

(2) the second and separately contained composition includes:
one (or more) Class B gibberellin biosynthesis inhibitors, which can include any one or more of the features described in any one or more of sections [I][A][1] and/or [I][A][2] (e.g., the Class B gibberellin biosynthesis inhibitor is α-(1-methylethyl)-α-[4-(trifluoromethoxy)phenyl]-5-pyrimidinemethanol (flurprimidol) and/or the Class B gibberellin biosynthesis inhibitor is (±)-(R*,R*)-beta-[(4-chlorophenyl)methyl]-alpha-(1,1-dimethylethyl)-1H-1,2,4-triazole-1-ethanol (paclobutrazol));
one (or more) pigments, which can include any one or more of the features described in section [I][D] above; and
one (or more) silicone surfactants, which can include any one or more of the features described in any one or more of sections [I][E][1], [I][E][2], and [I][E][3] above.

In some implementations, the combinations include a first and separately contained composition, a second and separately contained composition, and a third and separately contained composition, wherein:

(1) the first and separately contained composition includes:
one (or more) paraffinic oils, which can include any one or more of the features described in any one or more of sections [I][B][1], [I][B][2], and [I][B][3] above; and
one (or more) emulsifiers, which can include any one or more of the features described in any one or more of sections [I][C][1], [I][C][2], and [I][C][3] above; and

(2) the second and separately contained composition includes:
one (or more) pigments, which can include any one or more of the features described in section [I][D] above and
one (or more) silicone surfactants, which can include any one or more of the features described in any one or more of sections [I][E][1], [I][E][2], and [I][E][3] above.; and

(3) the third and separately contained composition includes:
one (or more) Class B gibberellin biosynthesis inhibitors, which can include any one or more of the features described in any one or more of sections [I][A][1] and/or [I][A][2] (e.g., the Class B gibberellin biosynthesis inhibitor is α-(1-methylethyl)-α-[4-(trifluoromethoxy)phenyl]-5-pyrimidinemethanol (flurprimidol) and/or the Class B gibberellin biosynthesis inhibitor is (±)-(R*,R*)-beta-[(4-chlorophenyl)methyl]-alpha-(1,1-dimethylethyl)-1H-1,2,4-triazole-1-ethanol (paclobutrazol)).

[2] Component Amounts in Combinations Having Two or More Composition (Concentrates)

In some of the implementations described in section [II][B][1], one or more of the following applies:

(2-aaa) the weight ratio of paraffinic oil to the emulsifier is from 10:1 to 500:1 (e.g., from 45:1 to 55:1, e.g., 49:1, 50:1);

(2-bbb) the weight ratio of paraffinic oil in a composition to the pigment (in the same or a different composition) is from 5:1 to 100:1 (e.g., from 25:1 to 35:1, e.g., 28:1, 30:1);

(2-ccc) the weight ratio of pigment to the silicone surfactant is from 2:1 to 50:1 (e.g., from 3:1 to 6:1, e.g., 4.5:1);

(2-ddd) the weight ratio of paraffinic oil in a composition to the Class B gibberellin biosynthesis inhibitor (in the same or a different composition) is from 90:1 to 200:1 (e.g., from 100:1 to 160:1; from 90:1 to 120:1, e.g., 111:1, 110:1; from 130:1 to 150:1, e.g., 139:1, 140:1; in certain implementations, the weight ratio of paraffinic oil to a formula (V) Class B gibberellin biosynthesis inhibitor, such as flurprimidol, is from 90:1 to 120:1, e.g., 111:1, 110:1; in certain implementations, the weight ratio of paraffinic oil to a formula (VI) Class B gibberellin biosynthesis inhibitor, such as paclobutrazol is from 130:1 to 150:1, e.g., 139:1, 140:1).

In certain implementations, (2-aaa) applies; or (2-aaa), (2-bbb) and (2-ccc) apply; or (2-bbb), and (2-ccc) apply. In certain implementations, (2-ddd) further applies to any one of the above-listed combinations of (2-aaa), (2-bbb) and (2-ccc).

In some of the implementations described in section [II][B][1], one or more of the following applies:

(2-aaaa) the composition (concentrate) includes from 50 to 200 parts per weight (e.g., 100) parts per weight of the paraffinic oil;

(2-bbbb) the composition (concentrate) includes from 1 to 10 parts per weight (e.g., 1.9, e.g., 2) parts per weight of the emulsifier;

(2-cccc) the composition (concentrate) includes from 1 to 10 parts per weight (e.g., 3.5) parts per weight of the pigment;

(2-dddd) the composition (concentrate) includes from 0.1 to 10 parts per weight (e.g., 0.8) parts per weight of the silicone surfactant;

(2-eeee) the composition (concentrate) includes from 0.5 to 20 parts per weight (e.g., 3.1) parts per weight of the anti-settling agent; or

(2-ffff) the composition (concentrate) includes from 0.1 to 10 parts per weight (e.g., 0.8) parts per weight of the Class B gibberellin biosynthesis inhibitor.

In certain implementations, (2-aaaa) and (2-bbbb) apply; or (2-aaaa) through (2-eeee) apply; or (2-ffff) applies; or (2-cccc), (2-dddd), and (2-ffff) apply; or (2-cccc) and (2-dddd) apply.

In certain implementations, (2-aaaa) through (2-eeee) apply in a composition (concentrate), and (2-ffff) applies in another composition (concentrate).

In certain implementations, (2-aaaa) and (2-bbbb) apply in a composition (concentrate), and (2-cccc), (2-dddd), and (2-ffff) apply in another composition (concentrate).

In certain implementations, (2-aaaa) through (2-eeee) apply in a composition (concentrate), (2-cccc) and (2-dddd) apply in a second composition (concentrate), and (2-ffff) applies in a third composition (concentrate).

In some implementations, any one or more of the features described in one or more of (2-aaa) and (2-ddd) can be combined with any one or more of the features described in one or more of (2-aaaa) and (2-ffff).

In some of the implementations described in section [II][B][1], the second composition can further include water (e.g., resulting in a dispersion of the pigment in the water).

In some of the implementations described in section [II][B][1], the first and second composition include the components present in Civitas™ 2-pack (Civitas Harmonizer™ 16:1) and those present in either Trimmit™ or Cutless™.

In some of the implementations described in section [II][B][1], the first and second composition include the components present in Civitas™ 2-pack (Civitas/Harmonizer™ 16:1), and the third composition includes the components present in either Trimmit™ or Cutless™.

[3]

In some of the implementations described in sections [II][B][1] and [II][B][2], each of the compositions, independently, further includes water. In certain implementations, the combination of compositions (concentrates) described above are combined and diluted with water (e.g., spray volume of the diluted end product is 1 to 5 gal/1000 ft2, e.g., 1 to 2 gal/1000 ft2). In certain implementations, oil in the end product is from 4 to 16 oz/1000 ft2 (other components can be calculated based on ratio with oil).

[C] As the skilled artisan will appreciate, the weight percent of a given component(s) can vary, e.g., due to dilution with water or whether the combination is in the form of a single composition or two or more separately contained compositions. In some implementations, the weight ratio of any two or more components is essentially the same regardless of whether the combination is in the form of a single composition (diluted with water or undiluted) or in the form two or more separately contained compositions (diluted with water or undiluted). In the latter case, this can be achieved by adjusting the component amounts in each of the separately contained compositions to match, for example, a weight percent ratio employed in single composition combination.

III. Application of Combinations

In general, the combinations can be applied to the plant by conventional methods known in the art, e.g., spraying, misting, sprinkling, pouring, or any other suitable method. The compositions may be reapplied as required. In some implementations, the combinations include both paraffinic oil and water.

It is advantageous to apply such combinations as oil-in-water (O/W) emulsions. In some implementations, an oil-in-water emulsion is prepared by a process that includes combining the paraffinic oil, water, and any other components and the paraffinic oil and applying shear until the emulsion is obtained. In other implementations, an oil-in-water emulsion is prepared by a process that includes combining the paraffinic oil, water, and any other components at the nozzle of a spray gun.

In other implementations, the combinations can include two or more separately contained (e.g., packaged) compositions, each containing one or more of the above-mentioned components. Said compositions can be combined and applied to a plant (e.g., turf grass) with or without prior dilution with water; or each composition can be applied separately to the same plant (e.g., turf grass) either simultaneously or sequentially, and each independently applied with or without prior dilution with water.

In the above-described implementations, application of any one (or more) compositions can be repeated one or more times.

In some implementations, any one or more of the following can apply:
the paraffinic oil is applied to a plant (e.g., turf grass) at a rate from 1.0 oz/1000 square ft to 32 oz/1000 square ft (e.g., from 4.0 oz/1000 square ft to 16 oz/1000 square ft);
the paraffinic oil is used or applied to the plant (e.g., turf grass) at an interval rate of, for example, from 7 days to 90 days (e.g., from 7 days to 28 days, from 7 days to 21 days, from 7 days to 14 days, from 14 days to 21 days, from 14 days to 28 days, 7 days, 10 days, 14, days, 21 days);
the Class B gibberellin biosynthesis inhibitor is applied to a plant (e.g., turf grass) at a rate from 0.015 lbs/acre to 1.50 lbs/acre;
the Class B gibberellin biosynthesis inhibitor of formula (V) (e.g., flurprimidol) is applied to a plant (e.g., turf grass) at a rate from 0.015 lbs/acre to 1.0 lbs/acre (e.g., from 0.060 lbs/acre to 0.25 lbs/acre);
the Class B gibberellin biosynthesis inhibitor of formula (VI) (e.g., paclobutrazol) is applied to a plant (e.g., turf grass) at a rate from 0.025 lbs/acre to 1.50 lbs/acre (e.g., from 0.10 lbs/acre to 0.25 lbs/acre); and
the Class B gibberellin biosynthesis inhibitor is used or applied to the plant at an interval rate of from 14 to 84 days (e.g., from 21 to 84 days, or from 14 to 56 days, or from 21 to 56 days, or from 14 to 42 days, or from 21 to 42 days, or from 14 to 35 days, or from 21 to 35 days, or from 14 to 28 days, or from 21 to 28 days).

In certain implementations, the interval rates for the paraffinic oil and the Class B gibberellin biosynthesis inhibitor overlap (e.g., when tank-mixed and applied at the same time). In other implementations, the interval rates for the paraffinic oil and the Class B gibberellin biosynthesis inhibitor do not overlap (e.g., when applied separately and/or sequentially).

In some implementations, the plant disease may be caused by, for example, a fungal pathogen, e.g., Sclerotinia homoeocarpa, Colletotrichum cereale, Rhizoctonia solani, Microdochium nivale, Pyricularia grisea, Rhizoctonia solani, Drechslera spp., Biopolaris spp, Leptosphaeria korrae, Erysiphe graminis, Laetisaria fuciformis, Typhula ishikariensis, Typhula incarnate, Ophiosphaerella korrae, Magnaporthe poae, or a combination thereof.

In certain implementations, the fungal pathogen is Sclerotinia homoeocarpa.

In some implementations, the turfgrass disease may be, for example, dollar spot, anthracnose, brown patch, crown rust, fusarium patch, gray leaf spot, large patch of zoysia, leaf spot, melting-out, necrotic ring, powdery mildew, red thread, grey snow mold, pink snow mold, southern blight, spring dead spot, summer patch, or a combination thereof.

In certain implementations, the fungal pathogen is a fungus that blights leaf tissue in a turfgrass.

In certain implementations, the fungal pathogen is a fungus that causes dollar spot in a turf grass.

In some implementations, the plant is a turf grass.

In certain implementations, the turf grass is one or more of: bentgrass, fine-leaf fescue, poa annua, tall fescue, seashore paspalum, Bermudagrass, zoysiagrass, bahiagrass, centipedegrass, or St. Augustinegrass.

In certain implementations, the turf grass is one or more of: bentgrass, bluegrass, ryegrass, fescue, bermudagrass, bahiagrass, zoysia, beachgrass, wheatgrass or carpetgrass.

In certain implementations, the turf grass is one or more of: creeping bentgrass, colonial bentgrass, perennial ryegrass, annual ryegrass, Kentucky bluegrass, common bermudagrass, hybrid bermudagrass, annual bluegrass, seashore paspalum, St. Augustinegrass, tall fescue, bahiagrass, zoysiagrass, centipedegrass, rough stalk bluegrass, buffalo grass, blue grama, or annual bentgrass.

In certain implementations, the turf grass is one or more of: creeping bentgrass or annual bluegrass.

In some implementations, the combinations described herein (e.g., combinations that include paclobutrazol or flurprimidol and the components present in CIVITAS/Harmonizer™) selectively suppress poa annua in bentgrass.

In some implementations, the combinations described herein can be prepared using the methods described in, for example, WO 2009/155693.

The features described in section III above can be combined with any one or more of the features described in sections I and II above.

Various implementations and examples of the combinations are described herein. These embodiments and examples are illustrative, and not limiting.

### EXAMPLES

Studies were established in a completely randomized design with three replications. The main treatments included a control (fertilizer only) and 6 rate/interval combinations of Civitas™, Cutless™ 50W, and Trimmit™ 2SC. The recommended rate of Civitas™ application on turfgrass are 8-32 oz/1000 sq.ft. The label-recommended rate of Cutless™ application for bentgrass putting greens is 2 to 8 oz/A. The label-recommended rate of Trimmit™ application for bentgrass putting greens is 0.10 to 0.25 lbs of a.i./A.

Initial treatments were made on June 17 and continued for 15 weeks (final treatments were made on September 27). Treatments were applied to experimental plots (4′×4′) on a mixed stand of creeping bentgrass/annual bluegrass (Agrostis palustris/Poa annua) native soil putting green turf (pH=6.7). The research area had been heavily modified with coring and straight sand topdressing resulting in a significant sand layer above the native soil.

Golf traffic was simulated daily during the season using a modified traffic device with two 0.5 meter diameter rollers that spin at different speeds to create slipping motion. The rollers were fitted with SoftSpikes. The amount of spikes and passes used were designed to simulate 30,000 rounds of golf.

The turf was mowed seven times per week at 0.115″ and clippings were collected. Fertility program included ammonium sulfate and iron sulfate applied every 7-10 days. Annual nitrogen rate was 2.5 lbs per 1000 sq feet; iron was applied at 2-4 ounces per application and Primo MAXX was applied at 0.125 ounces of product per 1000 square feet per application. Straight sand topdressing (pH 8.0) was applied every 14 days, typically in conjunction with light vertical mowing or grooming.

Precipitation was such that supplemental irrigation was not required on a regular basis. Data analysis was conducted using linear mixed models with compound symmetric covariance structure to assess treatment effects when repeated measurements were made on the same experimental unit over time. Treatment differences at individual measurement events were evaluated using analysis of variance and Fisher's protected least significant difference (LSD). The MIXED and GLM procedures in SAS/STAT software version 9.1 (SAS, Cary, N.C.) were used to perform the analyses.

TABLE 1
Treatment application regimes

| Treatment | | Rate/1000 | Interval |
|---|---|---|---|
| (Trt) # | Product | (oz/1000 ft²) | (days) |
| 1 | Untreated, fertilizer only | — | — |
| 2 | Civitas^{a}/Harmonizer^{b} | 16/1 | 14 |
| 3 | Cutless^{c} + Trt 2 | 0.125 | 21/14 |
| 4 | Trimmit^{d} + Trt 2 | 0.2 | 21/14 |

^{a}Civitas ™ available from Petro-Canada, Mississauga, ON, Canada
^{b}Civitas Harmonizer ™ available from Petro-Canada, Mississauga, ON, Canada
^{c}Cutless ™ available from SePRO Corporation, Carmel, IN, U.S.A.
^{d}Trimmit ™ available from Syngenta Crop Protection, Inc., Greensboro, NC, U.S.A.

### Turf Quality

Turf quality was assessed on 7 occasions using a scale of 1 to 9; where 1=poor quality, 9=excellent quality, and 6=acceptable quality (Table 2a). Season-long turf quality measurements are shown in Table 2b.

TABLE 2a
Effect of various treatments on turfgrass quality ratings.

| Treatment | | Rate/1000 | Interval | 29- | 17- | 27- | 7- | 20- | 4- | 25- |
|---|---|---|---|---|---|---|---|---|---|---|
| (Trt) # | Product | (oz/1000 ft²) | (days) | Jun | Jul | Jul | Aug | Aug | Sep | Sep |
| 1 | Untreated, | — | — | 5.6 | 5.4 | 5.3 | 5.8 | 5.3 | 5.8 | 6.0 |
| | fertilizer | | | | | | | | | |
| | only | | | | | | | | | |
| 2 | Civitas/ | 16/1 | 14 | 7.6 | 7.6 | 6.6 | 6.8 | 6.8 | 7.2 | 7.0 |
| | Harmonizer | | | | | | | | | |
| 3 | Cutless + | 0.125 | 21/14 | 7.7 | 7.4 | 7.8 | 7.9 | 7.1 | 7.7 | 8.0 |
| | Trt 2 | | | | | | | | | |
| 4 | Trimmit + | 0.2 | 21/14 | 7.6 | 7.3 | 8.2 | 7.9 | 7.5 | 8.0 | 8.3 |
| | Trt 2 | | | | | | | | | |

TABLE 2b
Effect of various treatments on season-
long turfgrass quality ratings.

| Treatment | | Rate/1000 | Interval | |
|---|---|---|---|---|
| (Trt) # | Product | (oz/1000 ft²) | (days) | TQ |
| 1 | Untreated, fertilizer only | — | — | 5.6 |
| 2 | Civitas/Harmonizer | 16/1 | 14 | 7.1 |
| 3 | Cutless + Trt 2 | 0.125 | 21/14 | 7.6 |
| 4 | Trimmit + Trt 2 | 0.2 | 21/14 | 7.8 |

The untreated (fertilizer only) treatment provided an acceptable turfgrass quality rating on one rating date 15 weeks into the trial. As illustrated in Tables 2a and 2b, the combination of Civitas and Cutless and the combination of Civitas and Trimmit provided excellent turfgrass quality at each date and when averaged over the season. The combination of Civitas and Cutless and the combination of Civitas and Trimmit provided turfgrass quality which exceeded that of Civitas when used alone. The excellent turfgrass quality measurements obtained using the combinations of Civitas and Cutless and Civitas and Trimmit were surprising since it would be expected that Cutless and Trimmit would have a negative impact on turfgrass quality. Cutless and Trimmit are understood to inhibit gibberellin biosynthesis in the early stages of the biosynthetic pathway, and this early inhibition prevents the synthesis of a number of gibberellins. Inhibition during the early stages of gibberellin biosynthesis can give rise to increased injury or phytotoxicity to turfgrasses (see, for example, B. Huang “Plant growth regulators: What and why” GCM, January (2007) pages 157-160).

### Normalized Difference Vegetation Index (NDVI)

NDVI, a measure of live green vegetation that provides an objective measure of turfgrass density and color, was assessed on four occasions using a TCM 500 meter from Spectrum Technology. Three readings per plot were used to obtain an average value (Table 3a). Season-long NDVI readings are shown in Table 3b.

TABLE 3a
Effect of various treatments on Normalized Difference Vegetation Index
(NDVI) readings

| Treatment | | Rate/1000 | Interval | | | | |
|---|---|---|---|---|---|---|---|
| (Trt) # | Product | (oz/1000 ft²) | (days) | 27-Aug | 10-Sep | 17-Sep | 1-Oct |
| 1 | Untreated, | — | — | 0.671 | 0.710 | 0.684 | 0.705 |
| | fertilizer only | | | | | | |
| 2 | Civitas/ | 16/1 | 14 | 0.720 | 0.719 | 0.668 | 0.696 |
| | Harmonizer | | | | | | |
| 3 | Cutless + | 0.125 | 21/14 | 0.724 | 0.746 | 0.687 | 0.721 |
| | Trt 2 | | | | | | |
| 4 | Trimmit + | 0.2 | 21/14 | 0.732 | 0.744 | 0.699 | 0.713 |
| | Trt 2 | | | | | | |

TABLE 3b
Effect of various treatments on season-long NDVI reading

| Treatment | | Rate/1000 | Interval | |
|---|---|---|---|---|
| (Trt) # | Product | (oz/1000 ft²) | (days) | NDVI |
| 1 | Untreated, fertilizer only | — | — | 0.693 |
| 2 | Civitas/Harmonizer | 16/1 | 14 | 0.701 |
| 3 | Cutless + Trt 2 | 0.125 | 21/14 | 0.719 |
| 4 | Trimmit + Trt 2 | 0.2 | 21/14 | 0.723 |

As illustrated in Tables 3a and 3b, turfgrass samples treated with the combination of Civitas and Cutless and the combination Civitas and Trimmit exhibited significantly higher NDVI measurements. These combination treatments averaged between 20 to 40% higher readings than the same Civitas rate applied alone. Treatments involving combinations of Civitas and Cutless and Civitas and Trimmit had a significant positive impact on turfgrass density and color.

### Clippings Production

A strip was mowed down the center of each plot, clippings collected, dried and weighed (Table 4).

TABLE 4
Effect of various treatments on clippings production

| Treatment | | Rate/1000 | Interval | |
|---|---|---|---|---|
| (Trt) # | Product | (oz/1000 ft²) | (days) | 19-Aug |
| 1 | Untreated, fertilizer only | — | — | 2.2 |
| 2 | Civitas/Harmonizer | 16/1 | 14 | 2.0 |
| 3 | Cutless + Trt 2 | 0.125 | 21/14 | 1.5 |
| 4 | Trimmit + Trt 2 | 0.2 | 21/14 | 1.1 |

### Dollar Spot

TABLE 5a
Effect of various treatments on dollar spots per plot

| Treatment | | Rate/1000 | Interval | |
|---|---|---|---|---|
| (Trt) # | Product | (oz/1000 ft²) | (days) | 20-Aug |
| 1 | Untreated, fertilizer only | — | — | 15.7 |
| 2 | Civitas/Harmonizer | 16/1 | 14 | 6.3 |
| 3 | Cutless + Trt 2 | 0.125 | 21/14 | 1.3 |
| 4 | Trimmit + Trt 2 | 0.2 | 21/14 | 1.3 |

TABLE 5b
Effect of Civitas, Cutless and Trimmit alone on
season-long dollar spots per plot (a separate trial
in a different location from Table 5a study)

| Treat- | | | | Mean number |
|---|---|---|---|---|
| ment | | Rate/1000 | Interval | of dollar |
| (Trt) # | Product | (oz/1000 ft²) | (days) | spots/plot |
| 1 | Untreated, fertilizer | — | — | 26.8 |
| | only | | | |
| 2 | Civitas/Harmonizer | 8/0.5 | 14 | 11.5 |
| 3 | Cutless | 0.125 | 21 | 12.7 |
| 4 | Trimmit | 0.4 | 21 | 16.3 |

A naturally occurring dollar spot infestation was rated 11 weeks after the trial was initiated. This would be classified as moderate disease pressure. The treatments with Trimmit and Cutless provided excellent dollar spot control (Table 5a). The fungicidal efficacy of Trimmit used alone and Cutless used alone would be expected to be, at best, equal to that of Civitas as shown in Table 5b. Table 5a illustrates that the efficacy of the combination of Trimmit or Cutless and Civitas in treating dollar spot exceeds the expected efficacy, evidencing a synergistic effect.

### Civitas+Trimmit on Plant Health (Turf Quality)

Materials and Methods

The experiment was conducted on a practice green in a golf course. The putting green was a 50:50 mix of creeping bentgrass (Agrostis stolonifera L.) and annual bluegrass (Poa annua L.) with a sand-based rootzone. Treatments listed in Table 1 were applied to three replicate during the year from June to October Products were applied biweekly with a CO₂ backpack sprayer operating at 40 PSI and in 130 GPA of water. The putting green turf were mowed at 0.135 inches 7 days each week. Irrigation occurred 4-5 days each week at 85% of reference evapotranspiration (ETₒ). Turf quality was assessed once each month from June to November on a 1-9 visual rating scale, where 9=best quality, 6=lowest acceptable quality, and 1=dead turf.

TABLE 1
Description of treatments used in the experiment.

| Treatment | Material(s) | Analysis (%)* | Rate | | Schedule | Dates |
|---|---|---|---|---|---|---|
| Untreated control | — | — | — | | — | — |
| Fertilizer | Nitroplast-S | 19N, 1P₂O₅, 4K₂O, | 0.05 lbs | | 2 wks | 6-30 to 10-7 |
| only | | 0.1Cu, 0.5Fe, 0.18Mn, | N/1000 | | | |
| | | 0.1Zn | | | | |
| | Andersons' | 14N, 7P₂O₅, 14K₂O, | 0.25 lbs | | once | 9-23 |
| | 14-7-14 | 9.56S, 0.29Fe, 0.14Mn | N/1000 | | | |
| Trimmit | Trimmit 2SC | 22.3% paclobutrazol | 8 | oz/A | 2 wks | 6-30 to 9-23 |
| C + H | Civitas | 98% mineral oil | 4 | oz/1000 | 2 wks | 6-30 to 10-7 |
| | | (petroleum distillates) | | | | |
| | Harmonizer | 100% proprietary | 1 | oz/1000 | 2 wks | 6-30 to 10-7 |
| | | pigment dispersion | | | | |
| C + H + | Civitas | 98% mineral oil | 4 | oz/1000 | 2 wks | 6-30 to 10-7 |
| Trimmit + | | (petroleum distillates) | | | | |
| fertilizer | Harmonizer | 100% proprietary | 1 | oz/1000 | 2 wks | 6-30 to 10-7 |
| | | pigment dispersion | | | | |
| | Trimmit 2SC | 22.3% paclobutrazol | 8 | oz/A | 2 wks | 6-30 to 9-23 |

| | | | | |
|---|---|---|---|---|
| Nitroplast-S | 19N, 1P₂O₅, 4K₂O, | 0.05 lbs | 2 wks | 6-30 to 10-7 |
| | 0.1Cu, 0.5Fe, 0.18Mn, | N/1000 | | |
| | 0.1Zn | | | |
| Andersons' | 14N, 7P₂O₅, 14K₂O, | 0.25 lbs | once | 9-23 |
| 14-7-14 | 9.56S, 0.29Fe, 0.14Mn | N/1000 | | |

Results

The treatments had significant effects on turf quality on all 5 rating dates, as measured once each month from July to November (Table 2).

TABLE 2
Effect of treatments on putting green turf quality.

| | Turf Quality^{x} | | | | | |
|---|---|---|---|---|---|---|
| | June | July | August | September | October | November |
| Treatment | (#) | | | | | |
| C + H + | 5.7^{y} | 8.0 a^{z} | 8.3 a | 8.3 a | 8.0 a | 8.0 a |
| Trimmit + | | | | | | |
| fertilizer | | | | | | |
| C + H | 5.7 | 7.0 ab | 7.7 ab | 5.3 c | 4.3 c | 3.7 c |
| Trimmit | 5.3 | 4.7 d | 5.3 ef | 1.7 e | 1.0 f | 3.0 c |
| Fertilizer | 6.0 | 5.3 cd | 5.7 de | 4.0 d | 3.3 d | 2.7 c |
| only | | | | | | |
| UTC | 5.0 | 6.0 bc | 4.7 f | 3.0 d | 2.0 e | 1.0 d |
| ANOVA | | | | | | |
| Treatment | ns | ** | *** | *** | *** | *** |

^{x}Turf quality rating scale 1-9; 9 = best, 6 = acceptable, 1 = dead turf.
^{y}Means before study initiation.
^{z}Means within same column with same letter are not different significantly, P = 0.05.
*, **, ***, ns, significant at P ≦ 0.05, 0.01, 0.001, or not significant respectively.

Overall, turf quality was significantly worse in the untreated control and Trimmit treated plots compared to the other treatments. Civitas+Harmonizer+trimmit treated plots had the best quality each month and this program significantly enhanced turf quality above all other treatments throughout the study (Table 2).

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein.

The invention includes all embodiments and variations substantially as hereinbefore described and with reference to the examples. Other implementations are within the scope of the following claims.

1. A composition comprising a paraffinic oil, a Class B gibberellin biosynthesis inhibitor, and an emulsifier.

2. The composition of claim 1, wherein the Class B gibberellin biosynthesis inhibitor has formula V: 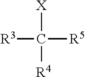
wherein:
R³ is 2-pyrazinyl, 3-pyridyl, or 5-pyrimidinyl;
R⁴ is phenyl, pyridyl, C₁-C₁₂ alkyl, or C₃-C₈ cycloalkyl;
R⁵ is trifluoromethoxyphenyl, tetrafluoroethoxyphenyl, pentafluoroethoxyphenyl, 3,4-(difluoromethylenedioxy)phenyl, or 2,2,4,4-tetrafluoro-1,3-benzodioxanyl; X is hydrogen, hydroxy, lower alkoxy, lower alkylthio, or lower alkanoyloxy; or an acid addition salt thereof.

3. The composition of claim 2, wherein the Class B gibberellin biosynthesis inhibitor is α-(1-methylethyl)-α-[4-(trifluoromethoxy)phenyl]-5-pyrimidinemethanol(flurprimidol).

4. The composition of claim 1, wherein the Class B gibberellin biosynthesis inhibitor has formula VI: 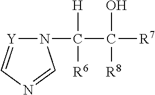
wherein:
R⁶ is alkenyl, alkynyl, or optionally substituted aralkyl;
Y is ═N— or ═C—;
R⁷ is cycloalkyl, alkyl, or haloalkyl; and
R⁸ is hydrogen, methyl or alkenyl;
or an ester, an ether, an acid addition salt or a metal complex thereof.

5. The composition of claim 1, wherein the Class B gibberellin biosynthesis inhibitor is (±)-(R*,R*)-beta-[(4-chlorophenyl)methyl]-alpha-(1,1-dimethylethyl)-1H-1,2,4-triazole-1-ethanol (paclobutrazol).

6. The composition of claim 1, wherein the weight ratio of paraffinic oil to the emulsifier is from 500:1 to 10:1, such as 50:1.

7. The composition of claim 1, wherein the paraffinic oil comprises a paraffin having from 16 carbon atoms to 35 carbon atoms.

8. The composition of claim 1, wherein the paraffinic oil has a paraffin content of at least 80%.

9. The composition of claim 1, wherein the paraffinic oil comprises synthetic isoparaffins.

10. The composition of claim 1, wherein the weight percent ratio of the Class B gibberellin biosynthesis inhibitor to the paraffinic oil is from 1:5 to 1:5000.

11. (canceled)

12. The composition of claim 1, wherein the emulsifier comprises a natural or synthetic alcohol ethoxylate, an alcohol alkoxylate, an alkyl polysaccharide, a glycerol oleate, a polyoxyethylene-polyoxypropylene block copolymer, an alkyl phenol ethoxylate, a polymeric surfactant, a polyethylene glycol, a sorbitan fatty acid ester ethoxylate, or a composition thereof.

13. The composition of claim 1, wherein the emulsifier comprises a natural or synthetic alcohol ethoxylate.

14. The composition of claim 1, wherein the composition further comprises a pigment.

15. The composition of claim 14, wherein the pigment is a polychlorinated (Cu II) phthalocyanine.

16. The composition of claim 14, wherein the weight ratio of the paraffinic oil to the pigment is from 5:1 to 100:1, such as 30:1.

17. The composition of claim 1, wherein the composition further comprises a silicone surfactant.

18. The composition of claim 17, wherein the silicone surfactant further comprises a polyethylene glycol according to formula IV:
R¹—O—(CH₂CH₂O)_{f}—R²
wherein R¹=H or CH₂═CH—CH₂ or COCH₃; R²=H or CH₂═CH—CH₂ or COCH₃; and f≧1.

19. The composition of claim 18, wherein the weight ratio of the pigment to the silicone surfactant is from 2:1 to 50:1.

20. The composition of claim 1, wherein the composition further comprises an anti-settling agent.

21. The composition of claim 20, wherein the anti-settling agent is fumed silica.

22. The composition of claim 18, wherein the weight ratio of pigment to the silicone surfactant is 4:1.

23. The composition of claim 14, wherein the pigment is stably dispersed in the composition

24. The composition of claim 1, wherein the composition comprises:

| | | |
|---|---|---|
| paraffinic oil | 50 to 300 | parts per weight |
| Class B gibberellin biosynthesis inhibitor | 0.1 to 10 | parts per weight |
| emulsifier | 1 to 10 | parts |
| pigment | 1 to 10 | parts per weight |
| silicone surfactant and polyethylene glycol | 0.1 to 10 | parts per weight |
| anti-settling agent | 0.5 to 20 | parts per weight |

25. The composition of claim 1, wherein the composition comprises:

| | | |
|---|---|---|
| paraffinic oil | 100 | parts per weight |
| Class B gibberellin biosynthesis inhibitor | 1 | parts per weight |
| emulsifier | 2 | parts per weight |
| pigment | 3.5 | parts per weight |
| silicone surfactant and polyethylene glycol | 1 | parts per weight |
| anti-settling agent | 2 | parts per weight |

26. The composition of claim 1, wherein the composition further comprises water.

27. The composition of claim 26, wherein the composition is in the form of an oil in water emulsion.

28. A combination comprising a first and separately contained composition and a second and separately contained composition, wherein:
the first and separately contained composition comprises a paraffinic oil and an emulsifier; and
the second and separately contained composition comprises a pigment and a silicone surfactant and a Class B gibberellin biosynthesis inhibitor,

29. A combination comprising a first and separately contained composition, a second and separately contained composition, and a third and separately contained composition, wherein:
the first and separately contained composition comprises a paraffinic oil and an emulsifier;
the second and separately contained composition comprises a pigment and a silicone surfactant; and
the third and separately contained composition comprises a Class B gibberellin biosynthesis inhibitor.

30. A method of regulating growth of a turf grass, the method comprising applying a composition of claim 1, to the turf grass.

31-45. (canceled)

46. A method of controlling a fungal pathogen of a plant, the method comprising applying a composition of claim 1 to the plant.

47-58. (canceled)

59. A method of regulating growth of a turf grass, the method comprising applying a composition a combination of claim 28 to the turf grass.

60. A method of regulating growth of a turf grass, the method comprising applying a composition a combination of claim 29 to the turf grass.

61. A method of controlling a fungal pathogen of a plant, the method comprising applying a combination of claim 28 to the plant.

62. A method of controlling a fungal pathogen of a plant, the method comprising applying a combination of claim 29 to the plant.
